(19) United States
(12) Patent Application Publication
(10) Pub. No.: US 2026/0066718 A1
(43) Pub. Date: Mar. 5, 2026

(54) STATOR AND MOTOR INCLUDING SAME

(71) Applicant: LG Magna E-Powertrain Co., Ltd., Incheon (KR)

(72) Inventors: Gookjin Seol, Incheon (KR); Chiho An, Incheon (KR); Jonghyun Lee, Incheon (KR); Yongsoo Kang, Incheon (KR); Jeongyeon Min, Incheon (KR)

(73) Assignee: LG Magna E-Powertrain Co., Ltd., Incheon (KR)

(21) Appl. No.: 19/313,103

(22) Filed: Aug. 28, 2025

(30) Foreign Application Priority Data
Aug. 29, 2024 (WO) PCT/KR2024/096083

(51) Int. Cl. H02K 1/16; H02K 3/28

(52) U.S. Cl. CPC H02K 1/16; H02K 3/28

(57) ABSTRACT

A stator and a motor including the same are disclosed. The stator according to an embodiment of the present disclosure includes: a stator core in which a plurality of slots are formed; and a plurality of windings between an inner periphery and an outer periphery of the stator core, and a first winding is disposed throughout a plurality of layers, a thickness of a second layer adjacent to the inner periphery is less than a thickness of a first layer adjacent to the outer periphery, and the first winding is connected in series in a first area, and connected in parallel in a second area, and the first winding includes a first hairpin, and a second hairpin having a larger length than the first hairpin. Accordingly, it is possible to reduce the heat generation upon the motor rotation while a number of welding members is reduced.

### CROSS-REFERENCE TO RELATED APPLICATION

This application claims the benefit of Korean Patent Application No. PCT/KR2024/096083, filed on 29 Aug. 2024, with the Korean Intellectual Property Office, the disclosure of which is incorporated herein by reference in its entirety.

### BACKGROUND

### 1. Field

The present disclosure relates to a stator and a motor including the same, and more particularly, to a stator capable of reducing motor driving device capable of reducing heat generation upon motor rotation while reducing a number of welding members, and a motor including the same.

### 2. Description of the Related Art

Electric vehicles that has electricity as power, or hybrid vehicles that combine internal combustion engines and these, generate outputs thereof using motors and batteries.

Meanwhile, for a vehicular motor, a circular motor or a hairpin motor is being developed.

In particular, for heat generation control, when using the hairpin motor, there is a disadvantage that heat generation is increasing toward a stator of the motor during high speed rotation.

### SUMMARY

The present disclosure has been made in view of the above problems, and provides a stator capable of reducing heat generation upon motor rotation while reducing a number of welding members, and a motor including the same.

The present disclosure further provides a stator capable of reducing heat generation around an inner periphery of a stator core while reducing a number of welding members, and a motor including the same.

The present disclosure further provides a stator capable of reducing heat generation by reducing alternating current (AC) resistance upon motor rotation, and a motor including the same.

The present disclosure further provides a stator capable of reducing heat generation upon motor rotation based on asymmetric winding, and a motor including the same.

In accordance with an aspect of the present disclosure, a stator and a motor including the same include: a stator core in which a plurality of slots are formed; and a plurality of windings between an inner periphery and an outer periphery of the stator core, and a first winding corresponding to a first phase among the plurality of windings is disposed throughout a plurality of layers between the outer periphery and the inner periphery of the stator core, a thickness of a second layer adjacent to the inner periphery is less than a thickness of a first layer adjacent to the outer periphery among the plurality of layers, and the first winding is connected in series in a first area between the outer periphery and the inner periphery of the stator core, and connected in parallel in a second area closer to the inner periphery than the first area between the outer periphery and the inner periphery, and the first winding includes a first hairpin disposed in the first area, and a second hairpin disposed in the second area and having a larger length than the first hairpin.

Meanwhile, the first winding may further include a first connection member connected to the first hairpin in the first area, and a second connection member connected to the second hairpin in the second area.

Meanwhile, a number of second connection members may be less than a number of first connection members.

Meanwhile, the second hairpin may include a first pin part spaced at a first interval, and a second pin part connected to the first pin part, and spaced at a second interval greater than the first interval.

Meanwhile, the second hairpin may include pin parts spaced at an equal interval.

Meanwhile, the second hairpin may include a first pin part spaced at a first interval, a second pin part spaced at a second interval greater than the first interval, and a third pin part spaced at a third interval greater than the first interval and less than the second interval.

Meanwhile, a number of third pin parts in the second hairpin may be greater than a number of first pin parts or a number of second pin parts.

Meanwhile, a size of the first area may be greater than a size of the second area.

Meanwhile, a thickness of the first hairpin may be greater than a thickness of the second hairpin.

Meanwhile, the first winding may include even wires.

Meanwhile, the first winding may be disposed throughout first to eighth layers toward the inner periphery from the outer periphery, and a thickness of the fifth to eighth layers may be less than a thickness of the first to fourth layers.

Meanwhile, some of the even wires in the first winding may be disposed in series in the first layer and the third layer, and disposed in parallel in the fifth layer and the seventh layer, and other some of the even wires in the first winding may be disposed in series in the second layer and the fourth layer, and disposed in parallel in the sixth layer and the eighth layer.

In accordance with another aspect of the present disclosure, a stator and a motor including the same include: a stator core in which a plurality of slots are formed; and a plurality of windings between an inner periphery and an outer periphery of the stator core, and a first winding corresponding to a first phase among the plurality of windings is disposed throughout a plurality of layers between the outer periphery and the inner periphery of the stator core, the first winding further includes a first hairpin disposed in a first area between the outer periphery and the inner periphery of the stator core, and second hairpin disposed in a second area closer to the inner periphery than the first area, and having a larger length than the first hairpin, and a number of second hairpins is less than a number of first hairpins.

### BRIEF DESCRIPTION OF THE DRAWINGS

The embodiments will be described in detail with reference to the following drawings in which like reference numerals refer to like elements wherein:

FIG. 1 is a schematic view showing a vehicle body of a vehicle according to an embodiment of the present disclosure;

FIG. 2 is an example of a motor drive system according to an embodiment of the present disclosure;

FIG. 3 illustrates an example of an internal block diagram of a motor driving device of FIG. 2;

FIG. 4 is an example of an internal circuit diagram of the motor driving device of FIG. 3;

FIG. 5 is an example of a perspective view of a motor according to an embodiment of the present disclosure;

FIG. 6 is an example of a perspective view of a stator according to an embodiment of the present disclosure;

FIG. 7A is an example of winding placement in the stator related to the present disclosure;

FIG. 7B is an example of winding connection of FIG. 7A;

FIG. 8A is an example of the winding placement in the stator according to an embodiment of the present disclosure;

FIG. 8B is an example of winding connection of FIG. 8A;

FIGS. 8C to 8E are various examples of the winding connection of FIG. 8A;

FIGS. 9A to 9C are examples of winding in the stator related to the present disclosure;

FIGS. 10A to 10C are examples of the winding in the stator according to an embodiment of the present disclosure;

FIGS. 11A and 11B are another examples of the winding in the stator according to an embodiment of the present disclosure;

FIGS. 12A and 12B are yet another examples of the winding in the stator according to an embodiment of the present disclosure; and

FIGS. 13A to 15D are diagrams referred to in the description of FIGS. 10A to 12B.

### DETAILED DESCRIPTION OF THE PREFERRED EMBODIMENTS

Reference will now be made in detail to the preferred embodiments of the present disclosure, examples of which are illustrated in the accompanying drawings. The suffixes “module” and “unit” in elements used in description below are given only in consideration of ease in preparation of the specification and do not have specific meanings or functions. Therefore, the suffixes “module” and “unit” may be used interchangeably.

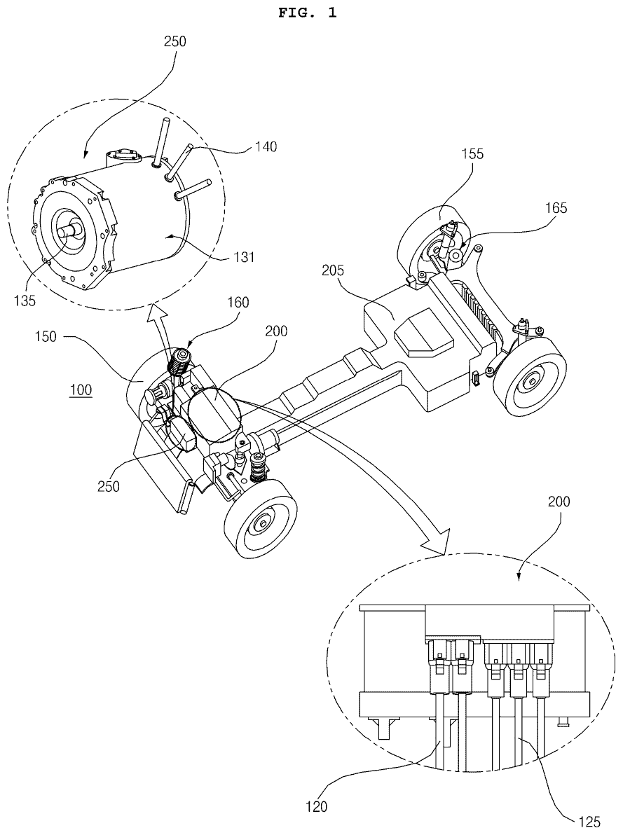

FIG. 1 is a schematic view showing a vehicle body of a vehicle according to an embodiment of the present disclosure.

Referring to the drawing, a vehicle 100 according to an embodiment of the present disclosure may include a battery 205 for supplying voltage, a motor driving device 200 that is supplied with voltage from the battery 205, a motor 250 that is driven and rotated by the motor driving device 200, a front wheel 150 and a rear wheel 155 that are rotated by the motor 250, a front wheel suspension device 160 and a rear wheel suspension device 165 that prevent the vibration due to the road surface from being transmitted to a vehicle body, an inclination angle detector 190 for detecting the inclination angle of the vehicle body. Meanwhile, a drive gear (not shown) for converting the rotational speed of the motor 250 based on a gear ratio may be additionally provided.

The battery 205 supplies voltage to the motor driving device 200. In particular, the DC voltage is supplied to a capacitor C in the motor driving device 200.

The battery 205 may be formed of a plurality of unit cells. The plurality of unit cells may be managed by a battery management system (BMS) to maintain a constant voltage, and may emit a constant voltage by the battery management system.

For example, the battery management system may detect the voltage Vbat of the battery 205, and transmit the detected voltage Vbat to an electronic controller (not shown) or an inverter controller 430 inside the motor driving device 200, may supply the DC voltage stored in a capacitor C in the motor driving device 200 to the battery when the battery voltage Vbat falls down to or below a lower limit. In addition, when the battery voltage Vbat rises up to or above an upper limit, DC voltage may be supplied to the capacitor C in the motor driving device 200.

The battery 205 is preferably configured as a secondary battery capable of charging and discharging, but is not limited thereto.

The motor driving device 200 receives DC voltage from the battery 205 via a voltage input cable 120. The motor driving device 200 converts the DC voltage received from the battery 205 into AC voltage and supplies to the motor 250. The converted AC voltage is preferably a three-phase AC voltage. The motor driving device 200 supplies three-phase AC voltage to the motor 250 through a three-phase output cable 125 provided in the motor driving device 200.

Although FIG. 1 shows that the motor driving device 200 has the three-phase output cable 125 composed of three cables, but three cables may be provided in a single cable.

Meanwhile, the motor driving device 200 according to an embodiment of the present disclosure will be described later with reference to FIG. 3 and below.

The motor 250 includes a stator 130 that is fixed without rotation and a rotor 135 that rotates. The motor 250 is provided with an input cable 140 to receive AC voltage supplied from the motor driving device 200. The motor 250 may be, for example, a three-phase motor, and the rotation speed of the rotor may be varied based on the applied frequency, when a voltage variable/frequency variable each phase AC voltage is applied to the coil of the stator of each phase.

The motor 250 may be implemented in various forms such as an induction motor, a blushless DC motor (BLDC) motor, a reluctance motor, and the like.

Meanwhile, one side of the motor 250 may be provided with a drive gear (not shown). The drive gear converts the rotational energy of the motor 250 based on the gear ratio. The rotational energy output from the drive gear is transmitted to the front wheel 150 and/or the rear wheel 155 to move the vehicle 100.

The front wheel suspension device 160 and the rear wheel suspension device 165 support the front wheel 150 and the rear wheel 155 respectively with respect to the vehicle body. The vertical direction of the front wheel suspension device 160 and the rear wheel suspension device 165 is supported by a spring or a damping mechanism so that the vibration due to the road surface does not affect the vehicle body.

The front wheel 150 may be further provided with a steering device (not shown). The steering device is a device for adjusting the direction of the front wheel 150 in order to drive the vehicle 100 in a direction intended by the driver.

Meanwhile, although not shown in the drawing, the vehicle 100 may further include an electronic controller for controlling the overall electronic devices in the vehicle. The electronic controller (not shown) controls each device to perform an operation, display, and the like. In addition, the above-described battery management system may be controlled.

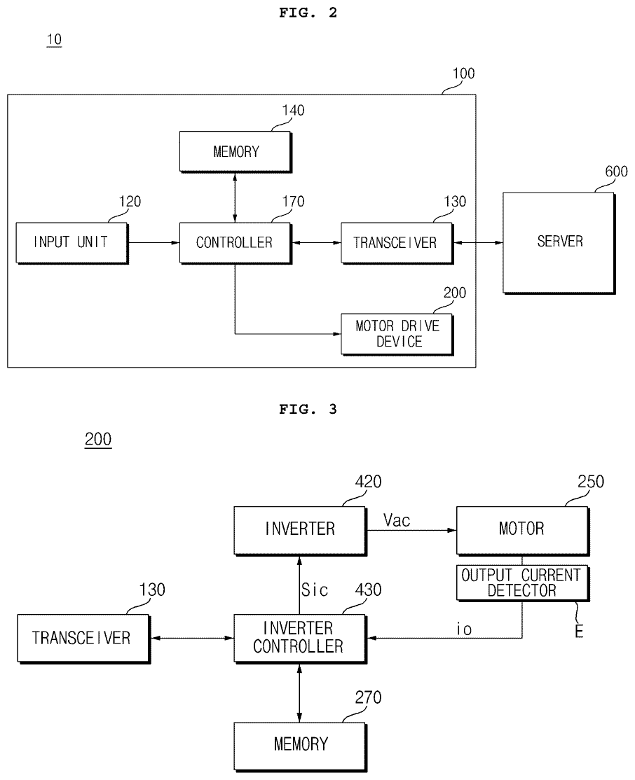

Meanwhile, the controller (170 in FIG. 2) may generate a driving command value according to various driving modes (traveling mode, reverse mode, neutral mode, parking mode, and the like) based on a detection signal from an inclination angle detector (not shown) for detecting the inclination angle of the vehicle 100, a speed detector (not shown) for detecting the speed of the vehicle 100, a brake detector (not shown) according to the motion of the brake pedal, an accelerator detector (not shown) according to the motion of the accelerator pedal, and the like. The driving command value at this time may be, for example, a torque command value.

Meanwhile, the vehicle 100 according to the embodiment of the present disclosure may include a hybrid electric vehicle using a battery and a motor while using an engine, as well as a pure electric vehicle using a battery and a motor.

In this case, the hybrid electric vehicle may further include a switching means capable of selecting at least one of a battery and an engine, and a transmission.

Meanwhile, the hybrid electric vehicle may be divided into a series method of driving the motor by converting the mechanical energy output from the engine into electrical energy, a parallel method of using the mechanical energy output from the engine and the electrical energy from the battery at the same time, and a series-parallel method of mixing them.

FIG. 2 is an example of a motor drive system according to an embodiment of the present disclosure.

Referring to the drawing, the motor drive system according to an embodiment of the present disclosure may include a vehicle 100 and a server 500.

Here, the server 500 may be a server operated by the manufacturer of the motor driving device 200 or the vehicle 100, or may correspond to a mobile terminal of the driver of the motor driving device 200 or the vehicle 100.

Meanwhile, the vehicle 100 may include an input device 120, a transceiver 130, a memory 140, a controller 170, and a motor driving device 200.

The input device 120 may include an operation button, a key, and the like, and output an input signal for voltage on/off, operation setting, etc. of the vehicle 100.

The transceiver 130 may exchange data with an external device, for example, the server 500 by wire or wirelessly, or may exchange data wirelessly with a remote server, or the like. For example, the transceiver 130 may perform mobile communication such as 4G or 5G, infrared (IR) communication, RF communication, Bluetooth communication, Zigbee communication, WiFi communication, and the like.

Meanwhile, the memory 140 of the vehicle 100 may store data necessary for the operation of the vehicle 100. For example, the memory 140 may store data related to an operation time, an operation mode, and the like during operation of the motor driving device 200.

In addition, the memory 140 of the vehicle 100 may store management data including voltage consumption information of the vehicle, recommend driving information, current driving information, and management information.

In addition, the memory 140 of the vehicle 100 may store diagnostic data including operation information, driving information, and error information of the vehicle.

The controller 170 may control each device in the vehicle 100. For example, the controller 170 may control the input device 120, the transceiver 130, the memory 140, the motor driving device 200, and the like.

The motor driving device 200 may be referred to as a motor driver, as a driver, to drive the motor 250.

Meanwhile, the motor driving device 200 may include an inverter 420 having a plurality of inverter switching elements and outputting AC voltage to the motor 250, an output current detector E for detecting an output current io flowing through the motor 250, and an inverter controller 430 for outputting a switching control signal to the inverter 420, based on current information (id, iq) based the output current io detected by output current detector E and torque command value T*.

Meanwhile, the current information (id, iq) based on the output current io and the torque command value T* may be transmitted to the external server 500, and may receive a current command value (i*d, i*q) from the server 500. The inverter controller 430 may output a switching control signal to the inverter 420, based on the current command value received from the transceiver 130.

Accordingly, the motor 250 may be driven based on the current command value corresponding to the maximum torque calculated in real time by the server 500. Thus, maximum torque drive of the motor 250 can be achieved.

Meanwhile, the transceiver 130 in the motor driving device 200 may transmit the current information (id, iq), the torque command value T*, and the voltage information related to the detected dc terminal voltage Vdc to the server 500. Accordingly, the maximum torque drive of the motor 250 under various conditions can be achieved.

Meanwhile, the detailed operation of the motor driving device 200 is described with reference to FIG. 3.

FIG. 3 illustrates an example of an internal block diagram of a motor driving device of FIG. 2.

Referring to the drawing, the motor driving device 200 according to the embodiment of the present disclosure is a drive device for driving the motor 250, and may include an inverter 420 which has a plurality of inverter switching elements (Sa˜Sc, S′a˜S′c) and outputs AC voltage to the motor 250, and an inverter controller 430 for controlling the inverter 420. Further, it may include a memory 270 that provides various stored data to the inverter controller 430.

Meanwhile, the motor driving device 200 according to the embodiment of the present disclosure may further include a capacitor C for storing a voltage Vdc of the dc terminal which is the input terminal of the inverter 420, a dc terminal voltage detector B for detecting the dc terminal voltage Vdc, and an output current detector E for detecting an output current flowing through the motor 250.

According to the embodiment of the present disclosure, the motor 250 may be a three-phase motor driven by the inverter 420.

Meanwhile, the inverter controller 430 may output the switching control signal Sic to the inverter 420, based on the current command value (i*d, i*q) corresponding to the calculated maximum torque. Accordingly, maximum torque driving of the motor 250 can be achieved.

The inverter controller 430 according to the embodiment of the present disclosure calculates the current information (id, iq) and the torque command value T* in real time, calculates the current command value (i*d, i*q) based on the torque command value T*, and drives the motor 250 using the current command values (i*d, i*q). Accordingly, the accuracy for high efficiency driving is improved.

Meanwhile, the motor driving device 200 may further include a capacitor C for storing the dc terminal voltage Vdc, which is an input terminal of the inverter 420, and a dc terminal voltage detector (B) for detecting the dc terminal voltage Vdc.

The inverter controller 430 calculates the current command value (i*d, i*q), based on the current information id, iq, the torque command value T*, and the detected dc terminal voltage Vdc, and drives the motor 250 by using the current command value i*d and i*q. Accordingly, the accuracy for high efficiency driving is improved.

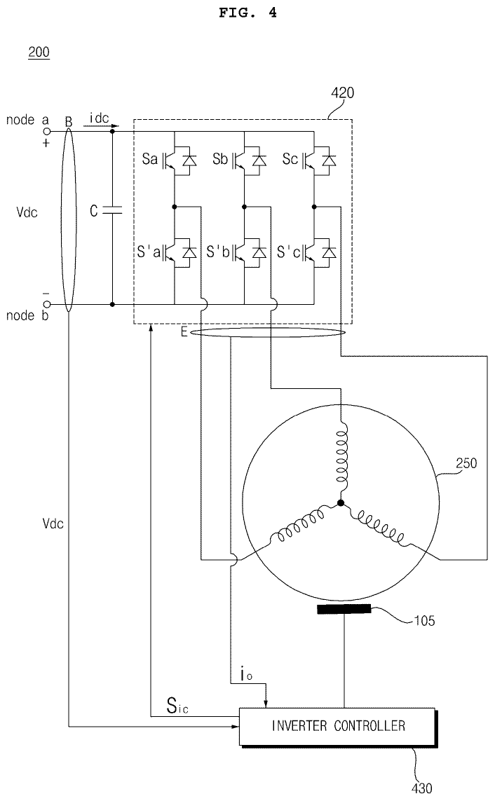

FIG. 4 is an example of an internal circuit diagram of the motor driving device of FIG. 3.

Referring to the drawing, the motor driving device 200 according to an embodiment of the present disclosure may include the inverter 420, the inverter controller 430, the output current detector E, the dc terminal voltage detector Vdc, and a position detection sensor 105.

Meanwhile, since the motor driving device 200 converts electric voltage to drive the motor, it may be referred to as a voltage converting device.

The dc terminal capacitor C stores the voltage input to the dc terminal (a-b terminal). In the drawing, a single device is exemplified as the dc terminal capacitor C, but a plurality of devices may be provided to ensure device stability.

Meanwhile, the input voltage supplied to the dc terminal capacitor C may be a voltage stored in the battery 205 or a voltage that is level-converted by a converter (not shown).

Meanwhile, since both ends of the dc terminal capacitor C store the DC voltage, these may be referred to as a dc terminal or a dc link terminal.

The dc terminal voltage detector B may detect the voltage Vdc of the dc terminal that is both ends of the dc terminal capacitor C. To this end, the dc terminal voltage detector B may include a resistor, an amplifier, and the like. The detected dc terminal voltage Vdc, as a discrete signal in the form of a pulse, may be input to the inverter controller 430.

The inverter 420 may include a plurality of inverter switching elements (Sa˜Sc, S′a˜S′c), and the turning on/off operation of the switching element (Sa˜Sc, S′a˜S′c) may convert the DC voltage Vdc into three-phase AC voltage Va, Vb, Vc having a certain frequency and output to the three-phase synchronous motor 250.

In the inverter 420, the upper arm switching element Sa, Sb, Sc and the lower arm switching element S′a, S′b, S′c which are connected in series with each other form a pair, and a total of three pairs of upper and lower arm switching elements are connected in parallel with each other (Sa&S′a, Sb&S′b, Sc&S′c). Diodes are connected in anti-parallel to each of the switching elements Sa, S′a, Sb, S′b, Sc, S′c.

The switching elements in the inverter 420 perform on/off operation of the respective switching elements based on the inverter switching control signal Sic from the inverter controller 430. Thus, the three-phase AC voltage having a certain frequency is output to the three-phase synchronous motor 250.

The inverter controller 430 may control a switching operation of the inverter 420, based on a sensorless method.

To this end, the inverter controller 430 may receive an output current io detected by the output current detector E.

The inverter controller 430 may output an inverter switching control signal Sic to each gate terminal of the inverter 420 in order to control the switching operation of the inverter 420. Accordingly, the inverter switching control signal Sic may be referred to as a gate driving signal.

Meanwhile, the inverter switching control signal Sic is a switching control signal of the pulse width modulation method PWM, and is generated and output based on the output current io detected by the output current detector E.

The output current detector E detects the output current io flowing between the inverter 420 and the three-phase motor 250. That is, the current flowing in the motor 250 may be detected.

The output current detector E may detect all of the output currents ia, ib, ic of each phase, or may detect the output currents of two phases by using three-phase equilibrium.

The output current detector E may be positioned between the inverter 420 and the motor 250, and a current transformer (CT), a shunt resistor, or the like may be used for current detection.

The detected output current io, as a discrete signal in the form of a pulse, may be applied to the inverter controller 430, and a switching control signal Sic is generated based on the detected output current io.

The position detection sensor 105 may sense rotor position information θ of the motor 250. The sensed position information θ may be input to the inverter controller 430.

Meanwhile, the three-phase motor 250 includes a stator and a rotor, and AC voltage of each phase having a certain frequency is applied to a coil of the stator of each phase (a, b, c phase), so that the rotor rotates.

Such a motor 250 may include, for example, a Surface-Mounted Permanent-Magnet Synchronous Motor (SMPMSM), an Interior Permanent Magnet Synchronous Motor (IPMSM), a Synchronous Reluctance Motor (Synrm), and the like. Among these, SMPMSM and IPMSM are a permanent magnet synchronous motor (PMSM) to which permanent magnet is applied, and Synrm has no permanent magnet.

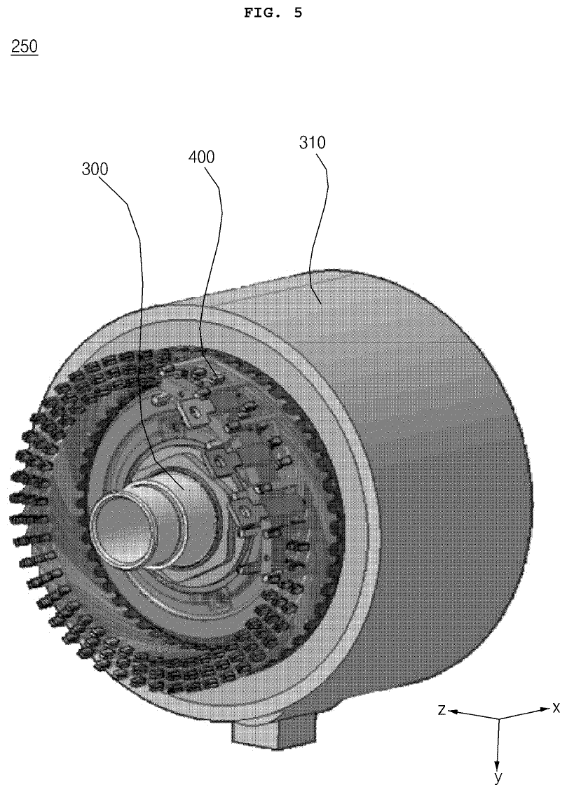

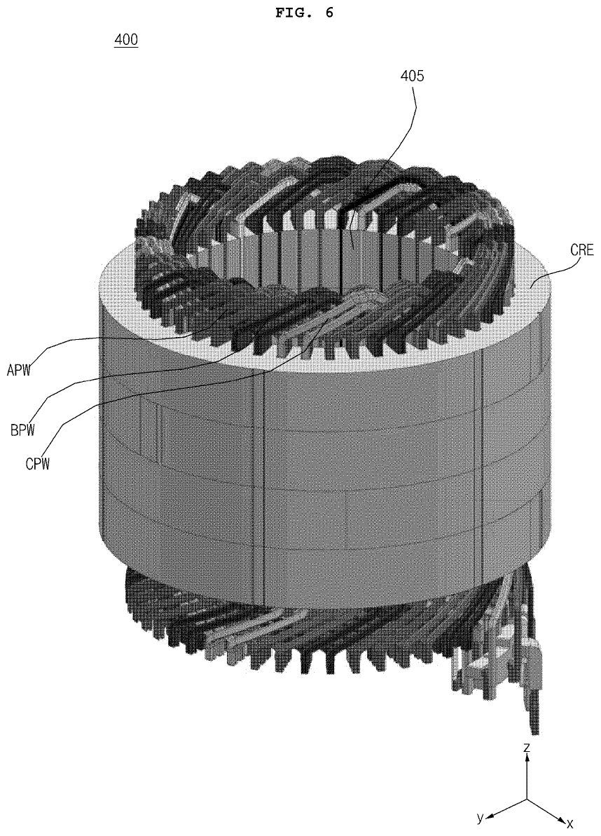

FIG. 5 is an example of a perspective view of a motor according to an embodiment of the present disclosure.

Referring to the drawing, the motor 250 according to an embodiment of the present disclosure includes a housing 310, a stator 400 located inside the housing 310, and a rotor 300 which is disposed and rotated in a hollow inside the stator 400.

Meanwhile, the rotor 300 may include a surface attached permanent magnet or a buried permanent magnet.

Meanwhile, the motor 250 according to an embodiment of the present disclosure includes a hairpin motor having a plurality of hairpins.

FIG. 6 is an example of a perspective view of a stator according to an embodiment of the present disclosure.

Referring to the drawing, the stator 400 according to an embodiment of the present disclosure includes a stator corer CRE in which a plurality of slots are formed, and a plurality of windings APW, BPW, and CPW between an inner periphery and an outer periphery of the stator core CRE.

Meanwhile, the hollow may be formed on the inner periphery of the stator core CRE, and the rotor 300 of FIG. 5 may be disposed.

Meanwhile, the housing 310 may be formed while being spaced apart from the outer periphery of the stator core CRE.

Meanwhile, the plurality of windings APW, BWP, and CPW may correspond to an a-phase winding APW, a b-phase winding BPW, and a c-phase winding CPW of a 3-phase motor 250 of FIG. 4.

That is, the a-phase winding APW is electrically connected to a node between a first inverter switching element Sa and a second inverter switching element Sa′ among a plurality of inverter switching elements Sa to Sc and S′a to S′c.

Similarly, the b-phase winding BPW is electrically connected to a node between a third inverter switching element Sb and a fourth inverter switching element Sb′ among the plurality of inverter switching elements Sa to Sc and S′a to S′c, and the c-phase winding CPW is electrically connected to a node between a fifth inverter switching element Sc and a sixth inverter switching element Sc′ among the plurality of inverter switching elements Sa to Sc and S′a to S′c.

Meanwhile, each of the plurality of windings APW, BPW, and CPW includes a plurality of hairpins. Accordingly, since a cross-sectional ratio of a conductor to the winding is higher than that of the circular motor, it is possible to implement a high-efficiency motor 250.

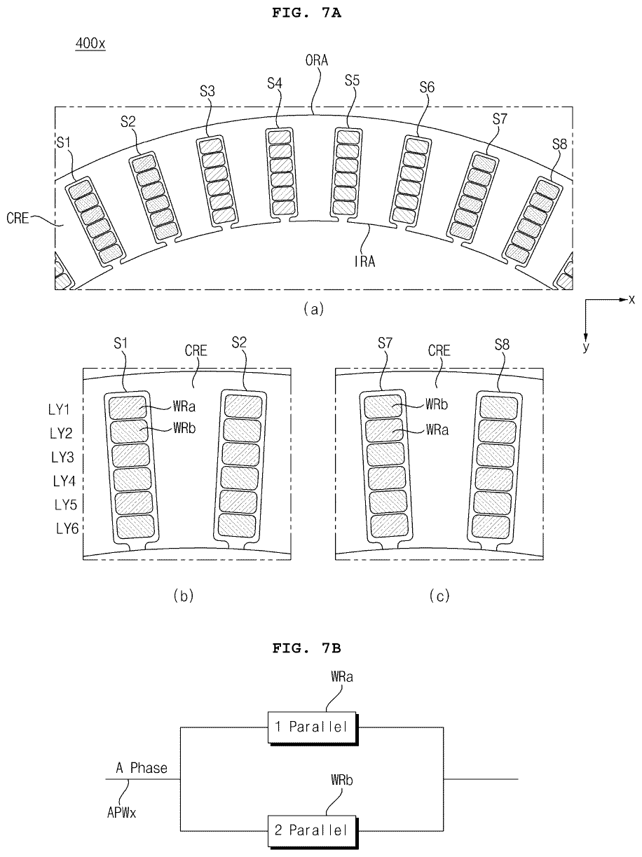

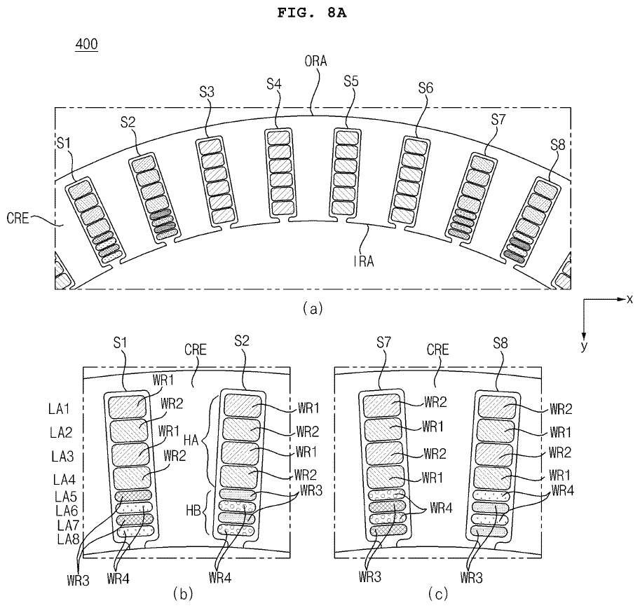

FIG. 7A is an example of the winding placement in the stator related to the present disclosure and FIG. 7B is an example of the winding connection of FIG. 7A.

Referring to the drawings, the stator 400x related to the present disclosure may include a stator core CRE in which a plurality of slots S1 to S8 are formed, and a plurality of windings, as illustrated in (a) of FIG. 7A.

At this time, the winding may include a plurality of hairpins.

Meanwhile, the plurality of windings in the stator 400x related to the present disclosure may be disposed throughout a plurality of layers LY1 to LY6 between an outer periphery ORA and an inner periphery IRA of the stator core CRE.

Meanwhile, the plurality of windings in the stator 400x related to the present disclosure may include even wires.

For example, a first winding APWx among the plurality of windings in the stator 400x related to the present disclosure may include some WRa and other some WRb among eve wires connected parallel to each other as illustrated in FIG. 7B.

Meanwhile, some WRa among the even wires in the first winding APWx may be disposed in a first layer LY1, a third layer LY3, and a fifth layer LY5 among the first to sixth layers LY1 to LY6 toward the inner periphery IRA from the outer periphery ORA in a first slot SLI and a second slot S2 among the plurality of slots S1 to S8, as illustrated in (b) of FIG. 7A.

Meanwhile, other some WRb among the even wires in the first winding APWx may be disposed in a second layer LY2, a fourth layer LY4, and a sixth layer LY6 among the first to sixth layers LY1 to LY6 toward the inner periphery IRA from the outer periphery ORA in the first slot SLI and the second slot S2, as illustrated in (b) of FIG. 7A.

Meanwhile, some WRa among the even wires in the first winding APWx may be disposed in the second layer LY2, the fourth layer LY4, and the sixth layer LY6 among the first to sixth layers LY1 to LY6 toward the inner periphery IRA from the outer periphery ORA in a seventh slot S7 and an eighth slot S8 among the plurality of slots S1 to S8, as illustrated in (c) of FIG. 7A.

Meanwhile, other some WRb among the even wires in the first winding APWx may be disposed in the first layer LY1, the third layer LY3, and the fifth layer LY5 among the first to sixth layers LY1 to LY6 toward the inner periphery IRA from the outer periphery ORA in the seventh slot S7 and the eighth slot S8, as illustrated in (c) of FIG. 7A.

As illustrated in FIGS. 7A and 7B, when the first winding APWx is constituted by the even wires, which are disposed in parallel, the first winding APWx comes closer to the inner periphery IRA than to the outer periphery ORA of the stator core CRE, a length of the winding becomes shorter, so a resistance of the winding disposed in the sixth layer LY6 among the first to sixth layers LY1 to LY6 becomes smallest.

Accordingly, when the motor 250 rotates, most current flows around the sixth layer LY6 around the inner periphery inside the stator 400x, and consequently, heat is generated severely.

Further, the first winding APWx is constituted by even wires, which are disposed in parallel in a symmetric scheme, so a circulation current by the first winding APWx in the stator 400x is generated.

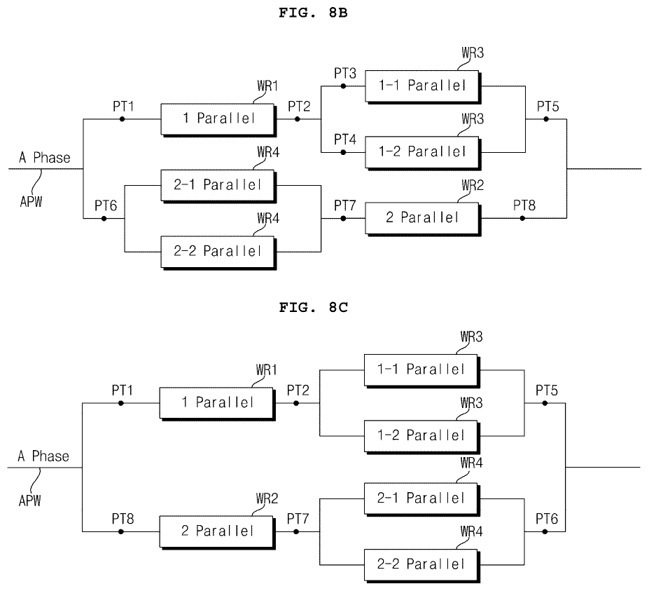

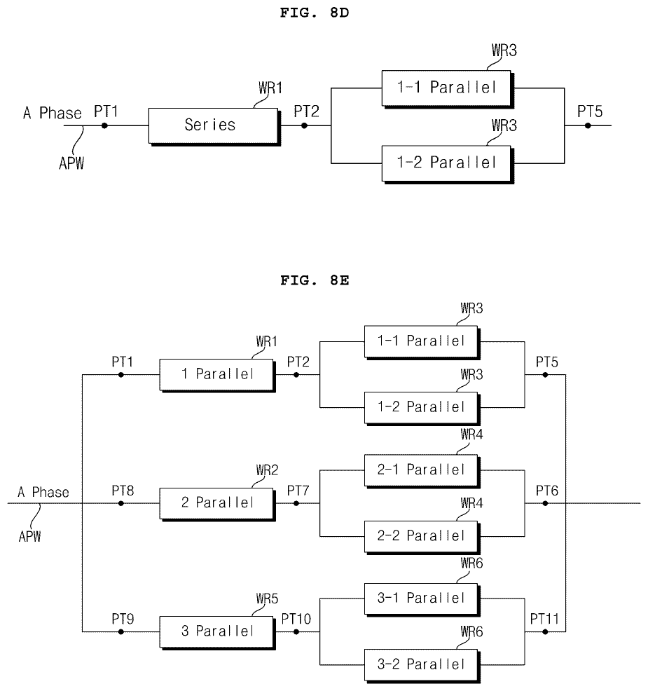

Accordingly, the present disclosure proposes a method in which the heat generation is reduced around the inner periphery IRA of the stator core CRE, and the circulation current is not generated. To this end, a winding scheme of asymmetrical serial and parallel mixing is adopted. This is described with reference to FIG. 8A or below.

FIG. 8A is an example of the winding placement in the stator according to an embodiment of the present disclosure and FIG. 8B is an example of winding connection of FIG. 8A.

Referring to the drawing, the stator 400 according to an embodiment of the present disclosure includes a stator corer CRE in which a plurality of slots S1 to S48 are formed, and a plurality of windings APW, BPW, and CPW between an inner periphery IRA and an outer periphery ORA of the stator core CRE, as illustrated in (a) of FIG. 8A.

Meanwhile, each of the plurality of windings APW, BPW, and CPW is disposed throughout a plurality of layers LA1 to LA8 between the outer periphery ORA and the inner periphery IRA of the stator core CRE.

Meanwhile, each of the plurality of windings APW, BPW, and CPW includes a plurality of hairpins.

For example, a first winding APW corresponding to a first phase among the plurality of windings APW, BPW, and CPW may be disposed throughout the plurality of layers LA1 to LA8 between the outer periphery ORA and the inner periphery IRA of the stator core CRE.

Meanwhile, it is desirable that a thickness of an eighth layer LA8 adjacent to the inner periphery IRA is less than a thickness of a first layer LA1 adjacent to the outer periphery ORA among the plurality of layers LA1 to LA8.

In FIG. 8A, it is illustrated that a thickness of each of a fifth layer to an eighth layer LA5 to LA8 adjacent to the inner periphery IRA is less than a thickness of the first layer to a fourth layer LA1 to LA4 adjacent to 2 adjacent to the outer periphery ORA among the plurality of layers LA1 to LA8.

For example, the thickness of each of the fifth layer to the eighth layer LA5 to LA8 adjacent to the inner periphery IRA may be a half of the thickness of each of the first layer to the fourth layer LA1 to LA4 adjacent to the outer periphery ORA among the plurality of layers LA1 to LA8.

Accordingly, as the winding comes closer to the inner periphery IRA than to the outer periphery ORA of the stator core CRE, it is supplemented that the length of the winding become shorter to allow a resistance of a winding in the fifth layer to the eighth layer LA5 to LA8 to be greater than a resistance of a winding in the first layer to the fourth layer LA1 to LA4.

Meanwhile, the first layer to the fourth layer LA1 to LA8 adjacent to the outer periphery ORA among the plurality of layers LA1 to LA8 may be referred to as a first area, and the fifth layer to the eighth layer LA5 to LA8 may be referred to as a second area.

Meanwhile, the first winding APW may be connected in series in the first area LA1 to LA8 between the outer periphery ORA and the inner periphery IRA o the stator core CRE, and connected in parallel in the second area LA5 to LA8 between the outer periphery ORA and the inner periphery IRA of the stator core CRE.

Meanwhile, the plurality of windings in the stator 400 according to an embodiment of the present disclosure may include even wires.

Meanwhile, it is desirable that the first winding APW among the plurality of windings in the stator 400 according to an embodiment of the present disclosure is the winding of the asymmetric serial and parallel mixing as illustrated in FIG. 8B.

For example, the first winding APW may include a serial part WR1 between point PT1 and point PT2, a parallel part WR3 between point PT2 and point PT5, a serial part WR2 between point PT7 and point PT8, and a parallel part WR4 between point PT6 and point PT7.

As described above, the first winding APW is constituted by even wires, which are disposed by the asymmetric scheme of the serial and parallel mixing, so the circulation current by the first winding APW in the stator 400 is not generated.

Meanwhile, the serial part WR1 which is some among the even wires in the first winding APW may be disposed in the first layer LA1 and the third layer LA3 among the first to eighth layers LA1 to LA8 toward the inner periphery IRA from the outer periphery ORA in the first slot S1 and the second slot S2 among the plurality of slots S1 to S8 as illustrated in (b) of FIG. 8A.

Meanwhile, the parallel part WR3 which is other some among the even wires in the first winding APW may be disposed in the fifth layer LA5 and the seventh layer LA7 among the first to eighth layers LA1 to LA8 toward the inner periphery IRA from the outer periphery ORA in the first slot S1 and the second slot S2 among the plurality of slots S1 to S8 as illustrated in (b) of FIG. 8A.

Meanwhile, the serial part WR2 which is some among the even wires in the first winding APW may be disposed in the second layer LA2 and the fourth layer LA4 among the first to eighth layers LA1 to LA8 toward the inner periphery IRA from the outer periphery ORA in the first slot S1 and the second slot S2 among the plurality of slots S1 to S8 as illustrated in (b) of FIG. 8A.

Meanwhile, the parallel part WR4 which is other some among the even wires in the first winding APW may be disposed in the sixth layer LA6 and the eighth layer LA8 among the first to eighth layers LA1 to LA8 toward the inner periphery IRA from the outer periphery ORA in the first slot S1 and the second slot S2 among the plurality of slots S1 to S8 as illustrated in (b) of FIG. 8A.

Meanwhile, the serial part WR2 which is some among the even wires in the first winding APW may be disposed in the first layer LA1 and the third layer LA3 among the first to eighth layers LA1 to LA8 toward the inner periphery IRA from the outer periphery ORA in the seventh slot S7 and the eighth slot S8 among the plurality of slots S1 to S8 as illustrated in (b) of FIG. 8A.

Meanwhile, the parallel part WR4 which is other some among the even wires in the first winding APW may be disposed in the fifth layer LA5 and the seventh layer LA7 among the first to eighth layers LA1 to LA8 toward the inner periphery IRA from the outer periphery ORA in the seventh slot S7 and the eighth slot S8 among the plurality of slots S1 to S8 as illustrated in (b) of FIG. 8A.

Meanwhile, the serial part WR1 which is some among the even wires in the first winding APW may be disposed in the second layer LA2 and the fourth layer LA4 among the first to eighth layers LA1 to LA8 toward the inner periphery IRA from the outer periphery ORA in the seventh slot S7 and the eighth slot S8 among the plurality of slots S1 to S8 as illustrated in (b) of FIG. 8A.

Meanwhile, the parallel part WR3 which is other some among the even wires in the first winding APW may be disposed in the sixth layer LA6 and the eighth layer LA8 among the first to eighth layers LA1 to LA8 toward the inner periphery IRA from the outer periphery ORA in the seventh slot S7 and the eighth slot S8 among the plurality of slots S1 to S8 as illustrated in (b) of FIG. 8A.

Meanwhile, as illustrated in FIGS. 8A and 8B, the thickness of the eighth layer LA8 adjacent to the inner periphery IRA is less than the thickness of the first layer LA1 adjacent to the outer periphery among the plurality of layers LA1 to LA8, and the first winding AP1 is constituted by even wires, which are disposed in the asymmetric scheme of the serial and parallel mixing, so it is possible to reduce the heat generation upon the motor rotation. In particular, the AC resistance upon the motor rotation is reduced to reduce the heat generation.

FIGS. 8C and 8D are various examples of the winding connection of FIG. 8A.

FIG. 8C illustrates that the first winding APW includes a serial part WR1 between point PT1 and point PT2, a parallel part WR3 between point PT2 and point PT5, a serial part WR2 between point PT8 and point PT7, and a parallel part WR4 between point PT7 and point PT6.

Meanwhile, FIG. 8C is different from FIG. 8B in that point PT1 and point PT8 are connected in parallel, and point PT5 and point PT6 are connected in parallel.

Meanwhile, the serial part WR1 which is some of the even wires in the first winding APW may be disposed in the first layer LA1 and the third layer LA3, as illustrated in (b) of FIG. 8A, and the parallel part WR3 which is other some may be disposed in the fifth layer LA5 and the seventh layer LA7, as illustrated in (b) of FIG. 8A.

Meanwhile, the serial part WR2 which is some of the even wires in the first winding APW may be disposed in the second layer LA2 and the fourth layer LA4, as illustrated in (b) of FIG. 8A, and the parallel part WR4 which is other some may be disposed in the sixth layer LA6 and the eighth layer LA8, as illustrated in (b) of FIG. 8A.

FIG. 8D illustrates that the first winding APW among the plurality of windings includes the serial part WR1 between point PT1 and point PT2, and the parallel part WR3 between point PT2 and point PT5.

Meanwhile, the serial part WR1 which is some of the even wires in the first winding APW may be disposed in the first layer LA1 and the third layer LA3, as illustrated in (b) of FIG. 8A, and the parallel part WR3 which is other some may be disposed in the fifth layer LA5 and the seventh layer LA7, as illustrated in (b) of FIG. 8A.

FIG. 8E illustrates that the first winding APW includes the serial part WR1 between point PT1 and point PT2, the parallel part WR3 between point PT2 and point PT5, the serial part WR2 between point PT8 and point PT7, the parallel part WR4 between point PT7 and point PT6, a serial part WR5 between point PT9 and point PT10, and a parallel part WR6 between point PT10 and point PT11.

Meanwhile, FIG. 8E is different from FIG. 8C in that point PT1, point PT8, and PT9 are connected in parallel, and point PT5, point PT6, and point PT10 are connected in parallel.

Accordingly, it is possible to reduce the heat generation upon the motor rotation. In particular, the AC resistance upon the motor rotation is reduced to reduce the heat generation. Furthermore, it is possible to reduce the heat generation upon the motor rotation based on asymmetric winding.

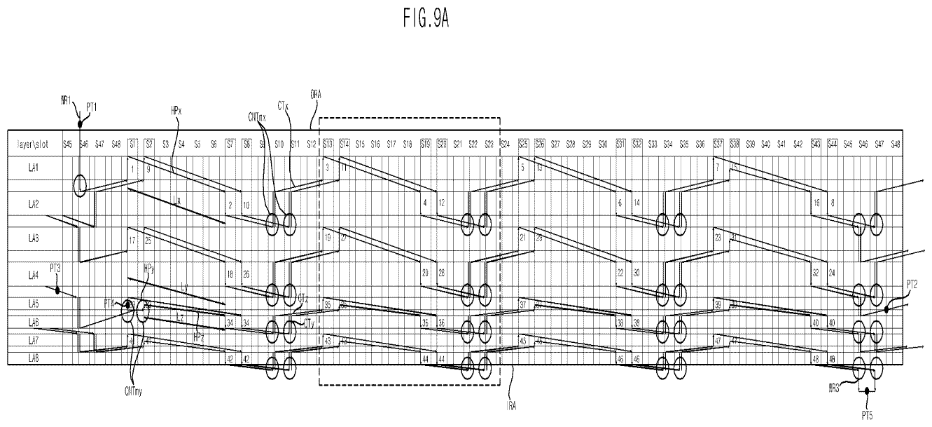

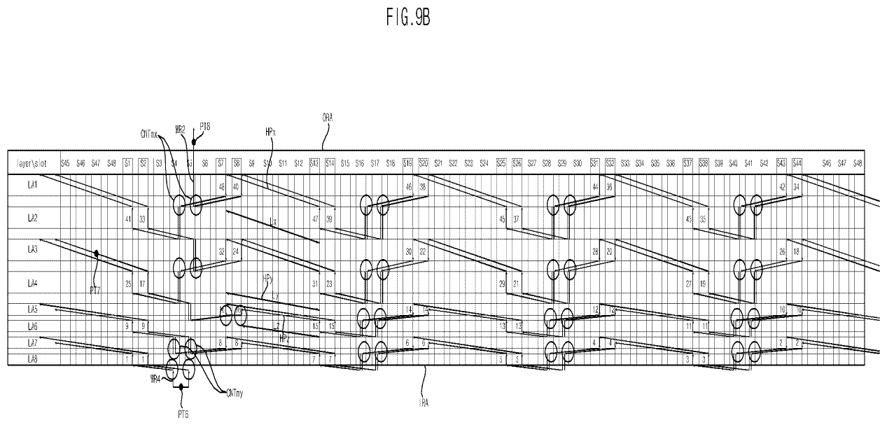

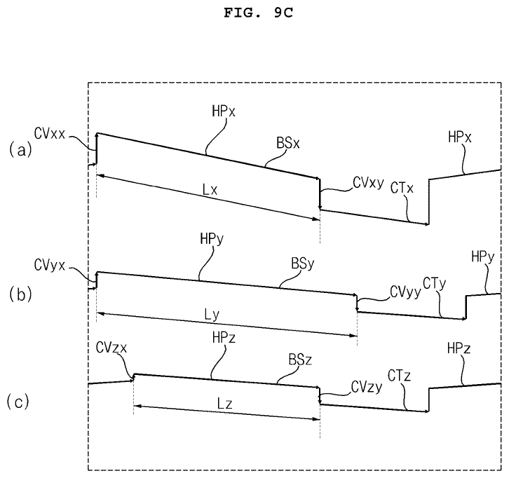

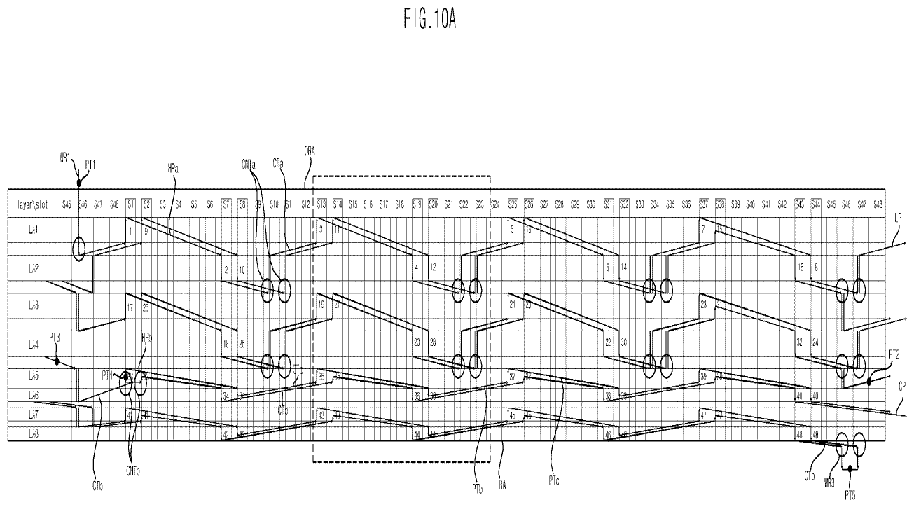

FIGS. 9A to 9C are examples of winding in the stator related to the present disclosure.

FIG. 9A illustrates a part of the first winding in the stator related to the present disclosure.

Referring to the drawing, a part of the first winding in the stator related to the present disclosure may be between point PT1 and point PT5 of FIG. 8B.

The first winding related to the present disclosure is disposed in the stator core CRE in which the plurality of slots S1 to S48 are formed.

Meanwhile, the serial part WR1 of the first winding related to the present disclosure is connected in series in the first area LA1 to LA4.

Meanwhile, the parallel part WR3 of the first winding related to the present disclosure is connected in parallel in the second area LA5 to LA8 between the outer periphery ORA and the inner periphery IRA of the stator core CRE.

Meanwhile, in the first area LA1 to LA4 between the outer periphery ORA and the inner periphery IRA of the stator core CRE, the serial part WR1 of the first winding includes a first hairpin HPx having length La, and a first connection member CTx connected to the first hairpin HPx.

Meanwhile, the parallel part WR3 of the first winding has a plurality of hairpins having different sizes in the second area LA5 to LA8 between the outer periphery ORA and the inner periphery IRA of the stator core CRE. That is, the plurality of hairpins having different sizes are disposed in the second area LA5 to LA8.

Specifically, in the second area LA5 to LA8 between the outer periphery ORA and the inner periphery IRA of the stator core CRE, the parallel part WR3 of the first winding includes a second hairpin HPy which has a larger length than the first hairpin HPx, and a third hairpin HPz which is disposed in the second area LA5 to LA8, and has a smaller length than the first hairpin HPx.

Meanwhile, the second hairpin HPy and the third hairpin HPz may be connected in parallel.

Meanwhile, in the second area LA5 to LA8 between the outer periphery ORA and the inner periphery IRA of the stator core CRE, the parallel part WR3 of the first winding may include a second connection member CTy connected to the second hairpin HPy in the second area LA5 to LA8, and a third connection member CTz connected to the third hairpin HPz in the second area LA5 to LA8.

Meanwhile, in the parallel part WR3 in the first winding, the second hairpin HPy having length Lb and the third hairpin HPz having length Lc may be alternately disposed.

FIG. 9B illustrates the other part of the first winding in the stator related to the present disclosure.

Referring to the drawing, the other part of the first winding in the stator related to the present disclosure may be between point PT6 and point PT8 of FIG. 8B.

Meanwhile, the parallel part WR4 of the first winding related to the present disclosure is connected in parallel in the second area LA5 to LA8.

Next, the serial part WR2 of the first winding related to the present disclosure is connected in series in the first area LA1 to LA4.

Meanwhile, in the first area LA1 to LA4 between the outer periphery ORA and the inner periphery IRA of the stator core CRE, the serial part WR2 of the first winding includes the first hairpin HPx having length La, and the first connection member CTx connected to the first hairpin HPx.

Meanwhile, the parallel part WR4 of the first winding has a plurality of hairpins having different sizes in the second area LA5 to LA8 between the outer periphery ORA and the inner periphery IRA of the stator core CRE. That is, the plurality of hairpins having different sizes are disposed in the second area LA5 to LA8.

Specifically, in the second area LA5 to LA8 between the outer periphery ORA and the inner periphery IRA of the stator core CRE, the parallel part WR4 of the first winding includes the second hairpin HPy which has the larger length than the first hairpin HPx, and the third hairpin HPz which is disposed in the second area LA5 to LA8, and has the smaller length than the first hairpin HPx.

Meanwhile, in the second area LA5 to LA8 between the outer periphery ORA and the inner periphery IRA of the stator core CRE, the parallel part WR4 of the first winding may further include the second connection member CTy connected to the second hairpin HPy in the second area LA5 to LA8, and the third connection member CTz connected to the third hairpin HPz in the second area LA5 to LA8.

Meanwhile, in the parallel part WR4 in the first winding, the second hairpin HPy having length Lb and the third hairpin HPz having length Lc may be alternately disposed.

FIG. 9C is a diagram illustrating a plurality of hairpins and a plurality of connection members in the first area and the second area of FIG. 9A or FIG. 9B.

Referring to the drawing, the first winding APW includes the first hairpin HPx having length La, the second hairpin HPy which is disposed in the second area LA5 to LA8, and has length Lb having a larger length than the first hairpin HPx, and the third hairpin HPz which is disposed in the second area LA5 to LA8, and has length Lc having a smaller length than the first hairpin HPx.

Meanwhile, the first winding APW may further include the first connection member CTx connected between the first hairpins HPx in the first area LA1 to LA4, the second connection member CTy connected between the second hairpins HPy in the second area LA5 to LA8, and the third connection member CTz connected between the third hairpins HPz in the second area LA5 to LA8.

Meanwhile, the first hairpin HPx disposed in the first area LA1 to LA4 may include a base BSx, a first curve part CVxx, and a second curve part CVxy. Meanwhile, a length of the base BSx of the first hairpin HPx may be Lx.

Meanwhile, the second hairpin HPy disposed in the second area LA5 to LA8 may include a base BSy, a first curve part CVyx, and a second curve part CVyy. Meanwhile, a length of the base BSy of the second hairpin HPy may be Ly.

Meanwhile, the third hairpin HPz disposed in the second area LA5 to LA8 may include a base BSz, a first curve part CVzx, and a second curve part CVzy. Meanwhile, a length of the base BSz of the third hairpin HPz may be Lz.

According to FIGS. 9A to 9C, the first winding includes the first hairpin HPx disposed in the first area LA1 to LA4, the first connection member CTx connected to the first hairpin HPx, the second hairpin HPy disposed in the second area LA5 to LA8, the second connection member CTy connected to the second hairpin HPy, and the third connection member CTz connected to the third hairpin HPz.

A number of first connection members CTx may be approximately 16, and a number of second connection members CTy and a number of third connection members CTz may be approximately 9.

Meanwhile, the first connection member CTx requires welding for electrical connection, and as a result, a welding member CNTmx by welding is attached as illustrated in FIGS. 9A and 9B.

Similarly, the second connection member CTy and the third connection member CTz require welding for electrical connection, and as a result, welding members CNTmy and CNTmz by welding are attached as illustrated in FIGS. 9A and 9B.

Meanwhile, a number of welding members CNTmx for the first connection member CTx may be approximately 16, a number of welding members CNTmy for the second connection member CTy and a number of welding members CNTmz for the third connection member CTz may be approximately 9.

That is, a number of welding members CNTmx in the first area LA1 to LA4, and a number of welding members CNTmy and CNTmz in the second area LA5 to LA8 may be approximately 19.

As described above, as a number of welding members is considerable, a task of the first winding is not easy.

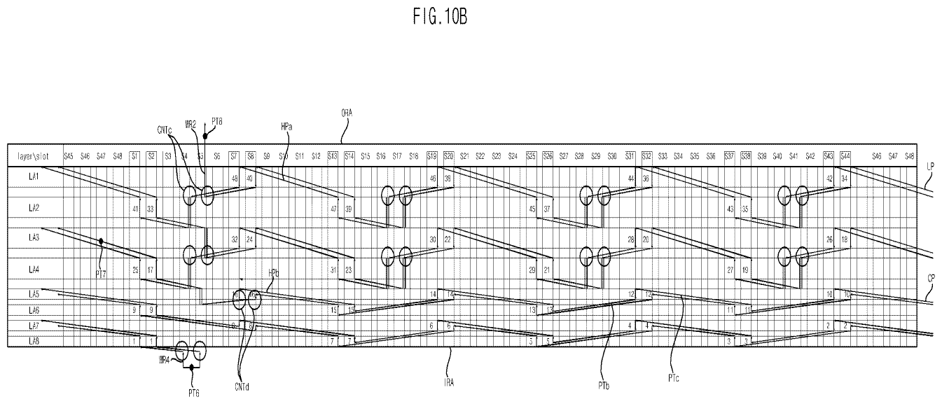

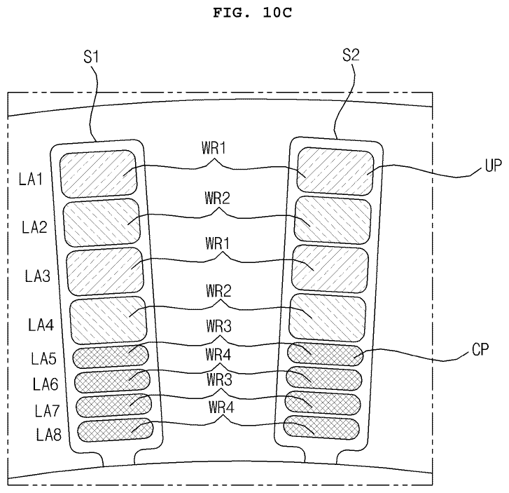

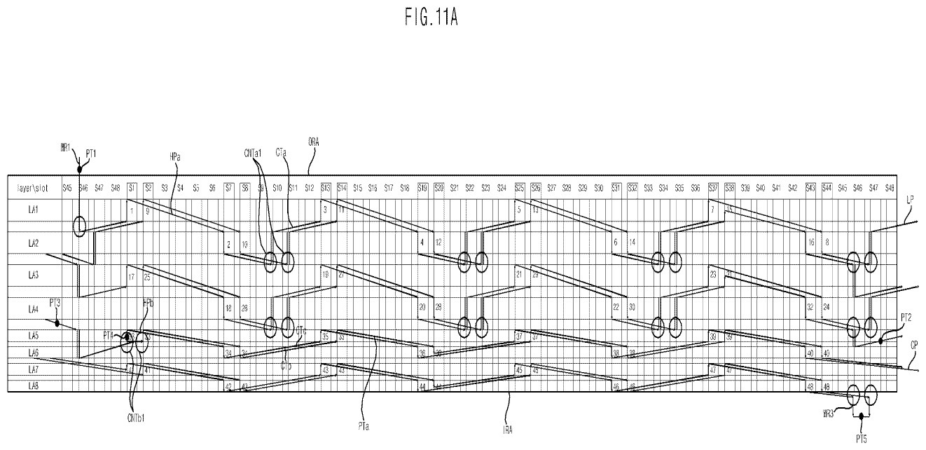

Therefore, the present disclosure proposes a method which may reduce the heat generation while reducing a number of welding members. In particular, the present disclosure proposes a method for reducing heat generation in an area around the inner periphery IRA of the stator core CRE while reducing a number of welding members. This is described with reference to FIG. 10A or below.

FIGS. 10A to 10C are examples of the winding in the stator according to an embodiment of the present disclosure.

FIG. 10A illustrates a part of the first winding in the stator according to an embodiment of the present disclosure.

Referring to the drawing, a part of the first winding in the stator according to an embodiment of the present disclosure may be between point PT1 and point PT5 of FIG. 8B.

The first winding according to an embodiment of the present disclosure is disposed in the stator core CRE in which the plurality of slots S1 to S48 are formed.

Meanwhile, the serial part WR1 of the first winding according to an embodiment of the present disclosure is connected in series in the first area LA1 to LA4.

That is, the serial part WR1 of the first winding according to the present disclosure goes via point PT1, the first slot S1 where point 1 is located, which starts to a 43^{rd} slot S43 where point 32 is located via points 2, 3, . . . , 31, and point PT2.

That is, the serial part WR1 of the first winding according to an embodiment of the present disclosure is connected in series in the first area LA1 to LA4 between the outer periphery ORA and the inner periphery IRA of the stator core CRE.

Next, the parallel part WR3 of the first winding between point PT3 or PT4, and point PT5 according to an embodiment of the present disclosure goes via point PT3 or PT4, the first slot S1 where point 33 is located, which starts to a 43^{rd} slot S43 where point 48 is located via points 33, 34, . . . , 47, and point PT5, respectively.

That is, the parallel part WR3 of the first winding according to an embodiment of the present disclosure is connected in parallel in the second area LA5 to LA8 between the outer periphery ORA and the inner periphery IRA of the stator core CRE.

Meanwhile, the first winding according to an embodiment of the present disclosure includes a first hairpin HPa disposed in the first area LA1 to LA4, and a second hairpin HPb which is disposed in the second area LA5 to LA8, and has a larger length than the first hairpin HPa.

That is, in the first area LA1 to LA4 between the outer periphery ORA and the inner periphery IRA of the stator core CRE, the serial part WR1 of the first winding includes the first hairpin HPa, and a first connection member CTa connected to the first hairpin HPa.

The first hairpin HPa at this time as a single hairpin may be a ‘U’-shaped hairpin.

For example, the first hairpin HPa may be between the first slot S1 as point 1 and the seventh slot S7 as point 2, between a 13^{th} slot S13 as point 3 and a 10^{th} slot S19 as point 4, between a 25^{th} slot S25 as point 5 and a 31^{st} slot S31 as point 6, and between a 37^{th} slot S37 as point 7 and a 43^{rd} slot S43 as point 8.

Meanwhile, the first connection member CTa may be between the seventh slot S7 as point 2 and the 13^{th} slot S13 as point 3, between the 19^{th} slot S19 as point 4 and the 25^{th} slot S25 as point 5, and between the 31^{st} slot S31 as point 6 and the 37^{th} slot S37 as point 7.

Meanwhile, in the second area LA5 to LA8 between the outer periphery ORA and the inner periphery IRA of the stator core CRE, the parallel part WR3 of the first winding includes a second hairpin HPb, and a second connection member CTb connected to the second hairpin HPb.

At this time, the second hairpin HPb may be a continuous hairpin.

For example, the second hairpin HPb may be between the first slot as point 33 and a 44^{th} slot S44 as point 48 or between the second slot S2 as point 33 and a 43^{rd} slot S43 as point 48.

Specifically, two second hairpins HPb which are continuous hairpins may be connected in parallel between point 33 and point 48.

Meanwhile, the second connection member CTb may be connected to each of the first slot (S1) part as point 33 of the second hairpin HPb and the 44^{th} slot (S44) part as point 48 of the second hairpin HPb.

Meanwhile, another second connection member CTb may be connected to each of the second slot (S2) part as point 33 of the second hairpin HPb and the 43^{rd} slot (S43) part as point 48 of the second hairpin HPb.

That is, two connection members CTb may be connected to both ends of one second hairpin HPb. Consequently, two second connection members CTb are connected to two second hairpins HPb connected in parallel, respectively, so a total of four second connection members CTb may be disposed.

As described above, since four connection members CTb are between the 33^{rd} slot S33 and the 48^{th} S48, a number of welding members CNTb for the second connection member CTb in the second area LA5 to LA8 may be approximately 4.

Meanwhile, in the first winding of FIG. 10A, a number of welding members CNTa in the first area LA1 to LA4 may be approximately 16, and a number of welding members CNTb in the second area LA5 to LA8 may be approximately 4.

When FIGS. 9A to 9C are compared, FIGS. 9A to 9C are the same as each other in terms of a number of welding members CNTa, but a number of welding members CNTb in the second area LA5 to LA8 is remarkably reduced.

Meanwhile, the resistance in the second area LA5 to LA8 may be reduced, and it is possible to reduce the heat generation upon the motor rotation. In particular, the heat generation may be reduced around the inner periphery IRA of the stator core CRE.

Meanwhile, when the first area LA1 to LA4 and the second area LA5 to LA8 are compared, it is desirable that a number of second connection members CTb is less than a number of first connection members CTa. Accordingly, the heat generation may be reduced around the inner periphery IRA of the stator core CRE while a number of welding members is reduced.

Meanwhile, the second hairpin HPb may include a first pin part PTb spaced at a first interval, and a second pin part PTc connected to the first pin part PTb, and spaced at a second interval greater than the first interval.

That is, the first pin part PTb may be disposed at an interval of five slots, and the second pin part PTc may be disposed at an interval of seven slots.

In the drawing, it is illustrated that the first pin part PTb and the second pin part PTc are alternately disposed in the second hairpin HPb.

Accordingly, a number of first pin parts PTb in the second hairpin HPb may be the same as a number of second pin parts PTc.

Due to such asymmetric placement, it is possible to reduce the heat generation upon the motor rotation. In particular, the AC resistance upon the motor rotation is reduced to reduce the heat generation. Furthermore, it is possible to reduce the heat generation upon the motor rotation based on asymmetric winding.

Meanwhile, according to another embodiment of the present disclosure, a number of second hairpins HPb is less than a number of first hairpins HPa.

In the drawing, it is illustrated that a number of first hairpins HPa is approximately 16, and a number of second hairpins HPb connected in parallel is 2.

Meanwhile, the resistance in the second area LA5 to LA8 may be reduced, and it is possible to reduce the heat generation upon the motor rotation. In particular, the heat generation may be reduced around the inner periphery IRA of the stator core CRE.

FIG. 10B illustrates the other part of the first winding in the stator according to an embodiment of the present disclosure.

Referring to the drawing, the other part of the first winding in the stator according to an embodiment of the present disclosure may be between point PT6 and point PT8 of FIG. 8B.

Meanwhile, the parallel part WR4 of the first winding according to an embodiment of the present disclosure is connected in parallel in the second area LA5 to LA8.

That is, the parallel part WR4 of the first winding according to an embodiment of the present disclosure goes via point PT6, and the first slot S1 or the second slot S2 where point 1 is located, which starts to the seventh slot S7 or the eighth slot S8 where point 16 is located via points 2, 3, . . . , 15.

Next, the serial part WR2 of the first winding according to an embodiment of the present disclosure is connected in series in the first area LA1 to LA4.

That is, the serial part WR2 of the first winding according to an embodiment of the present disclosure goes via point PT7, and the second slot S2 where point 17 is located, which starts to the seventh slot S7 where point 48 is located via points 18, 19, . . . , 47.

Meanwhile, the first winding according to an embodiment of the present disclosure includes the first hairpin HPa disposed in the first area LA1 to LA4, and the second hairpin HPb which is disposed in the second area LA5 to LA8, and has the larger length than the first hairpin HPa.

That is, in the first area LA1 to LA4 between the outer periphery ORA and the inner periphery IRA of the stator core CRE, the serial part WR2 of the first winding includes the first hairpin HPa, and the first connection member CTa connected to the first hairpin HPa.

The first hairpin HPa at this time as a single hairpin may be a ‘U’-shaped hairpin.

For example, the first hairpin HPa may be between the second slot S2 as point 17 and the 44^{th} slot S44 as point 18, between a 38^{th} slot S38 as point 19 and a 32^{nd} slot S32 as point 20, between a 26^{th} slot S26 as point 21 and a 20^{th} slot S20 as point 22, and between a 14^{th} slot S14 as point 23 and the eighth slot S8 as point 24.

Meanwhile, the first connection member CTa may be between the 44^{th} slot S44 as point 18 and the 38^{th} slot S38 as point 19, between the 32^{nd} slot S32 as point 20 and the 26^{th} slot S26 as point 21, between the 20^{th} slot S20 as point 22 and the 14^{th} slot S14 as point 23, and between the seventh slot S7 as point 24 and the first slot S1 as point 25.

Meanwhile, in the second area LA5 to LA8 between the outer periphery ORA and the inner periphery IRA of the stator core CRE, the parallel part WR3 of the first winding includes the second hairpin HPb, and the second connection member CTb connected to the second hairpin HPb.

At this time, the second hairpin HPb may be the continuous hairpin.

For example, the second hairpin HPb may be between the first slot S1 as point 1 and the eighth slot S8 as point 16 or between the second slot S2 as point 1 and the seventh slot S7 as point 16.

Specifically, two second hairpins HPb which are the continuous hairpins may be connected in parallel between point 1 and point 16.

Meanwhile, the second connection member CTb may be connected to each of the first slot (S1) part as point 1 of the second hairpin HPb and the eighth slot (S8) part as point 16 of the second hairpin HPb.

Meanwhile, another second connection member CTb may be connected to each of the second slot (S2) part as point 1 of the second hairpin HPb and the seventh slot (S7) part as point 16 of the second hairpin HPb.

That is, two connection members CTb may be connected to both ends of one second hairpin HPb. Consequently, two second connection members CTb are connected to two second hairpins HPb connected in parallel, respectively, so a total of four second connection members CTb may be disposed.

As described above, since four connection members CTb are disposed, a number of welding members CNTd for the second connection member CTb in the second area LA5 to LA8 may be approximately 4.

Meanwhile, in the first winding of FIG. 10B, a number of welding members CNTc in the first area LA1 to LA4 may be approximately 16, and a number of welding members CNTd in the second area LA5 to LA8 may be approximately 4.

When FIGS. 9A to 9C are compared, FIGS. 9A to 9C are the same as each other in terms of a number of welding members CNTc, but a number of welding members CNTd in the second area LA5 to LA8 is remarkably reduced.

Meanwhile, the resistance in the second area LA5 to LA8 may be reduced, and it is possible to reduce the heat generation upon the motor rotation. In particular, the heat generation may be reduced around the inner periphery IRA of the stator core CRE.

Meanwhile, referring to FIGS. 10A and 10B, it is desirable that a size of the first area LA1 to LA4 is greater than a size of the second area LA5 to LA8.

Meanwhile, according to FIGS. 10A and 10B, a thickness of the first hairpin HPa may be greater than a thickness of the second hairpin HPb or HPC. Accordingly, it is possible to reduce the heat generation upon the motor rotation while a number of welding members is reduced.

Meanwhile, according to FIGS. 10A and 10B, the first winding APW may include even wires.

In particular, the first winding APW may be disposed throughout the first to eighth layers LA1 to LA8 toward the inner periphery IRA from the outer periphery ORA, and a thickness of the first layer to the eight layer LAT5 to LA8 may be less than a thickness of the first layer to the fourth layers LA1 to LA4. Accordingly, it is possible to reduce the heat generation upon the motor rotation while a number of welding members is reduced.

FIG. 10C is a diagram illustrating windings in the first slot and the second slot in FIG. 10A or 10B.

Referring to the drawing, as illustrated in FIG. 10A, some WR1 among the even wires in the first winding APW is disposed in series in the first layer LA1 and the third layer LA3 in the first slot S1 and the second slot S2, and other some WR3 is disposed in parallel in the fifth layer LA5 and the seventh layer LA7.

Meanwhile, as illustrated in FIG. 10B, yet another some WR2 among the even wires in the first winding APW is disposed in series in the second layer LA2 and the fourth layer LA4 in the first slot S1 and the second slot S2, and still yet another some WR4 is disposed in parallel in the sixth layer LA6 and the eighth layer LA8. Accordingly, it is possible to reduce the heat generation upon the motor rotation while a number of welding members is reduced.

Consequently, as illustrated in FIG. 10C, in the first slot S1 and the second slot S2, the serial part WR1 in the first winding APW is disposed in the first layer LA1 and the third layer LA3 among the first to eight layers LA1 to LA8, the serial part WR2 in the first winding APW is disposed in the second layer LA2 and the fourth layer LA4, the parallel part WR3 in the first winding APW is disposed in the fifth layer LA5 and the seventh layer LA7, and the parallel part WR4 in the first winding APW is disposed in the sixth layer LA6 and the eighth layer LA8.

Meanwhile, the stator 400 according to another embodiment of the present disclosure includes a plurality of windings APW, BPW, and CPW between the inner periphery IRA and the outer periphery ORA of the stator core CRE, and a first winding APW corresponding to a first phase among the plurality of windings APW, BPW, and CPW includes a first hairpin HPa disposed in a first area LA1 to LA4 between the inner periphery IRA and the outer periphery ORA of the stator core CRE, and a second hairpin HPb which is disposed in a second area LA5 to LA8 closer to the inner periphery IRA than the first area LA1 to LA4, and has a larger length than the first hairpin HPa.

At this time, the first hairpin HPa as a single hairpin may be a ‘U’-shape hairpin UP and the second hairpin HPb may be a continuous hairpin CP. Accordingly, it is possible to reduce the heat generation upon the motor rotation while a number of welding members is reduced. In particular, the AC resistance upon the motor rotation is reduced to reduce the heat generation.

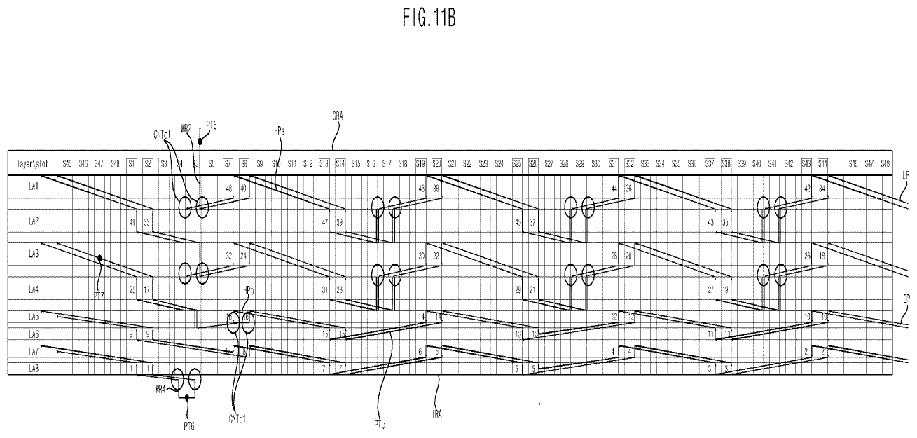

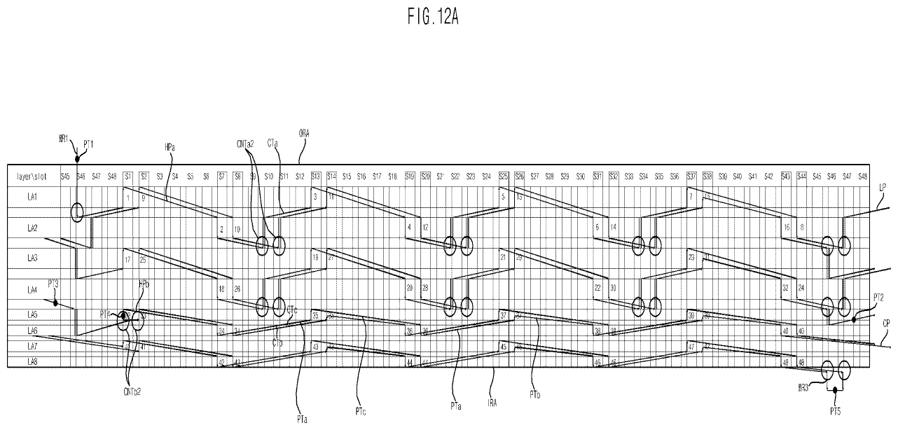

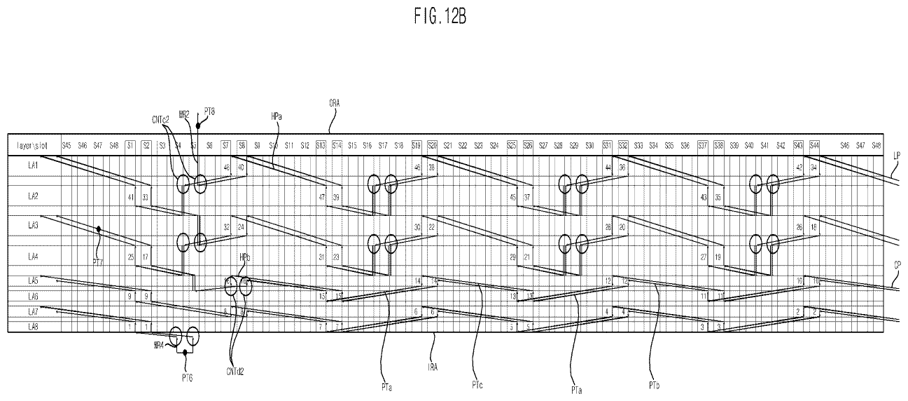

FIGS. 11A and 11B are other examples of the winding in the stator according to an embodiment of the present disclosure.

FIG. 11A illustrates a part of the first winding in the stator according to an embodiment of the present disclosure.

Referring to the drawing, the serial part WR1 of the first winding according to an embodiment of the present disclosure is connected in series in the first area LA1 to LA4.

Meanwhile, the parallel part WR3 of the first winding according to an embodiment of the present disclosure is connected in parallel in the second area LA5 to LA8 between the outer periphery ORA and the inner periphery IRA of the stator core CRE.

Meanwhile, the first winding according to an embodiment of the present disclosure includes the first hairpin HPa disposed in the first area LA1 to LA4, and the second hairpin HPb which is disposed in the second area LA5 to LA8, and has the larger length than the first hairpin HPa.

Meanwhile, in the first area LA1 to LA4 between the outer periphery ORA and the inner periphery IRA of the stator core CRE, the serial part WR1 of the first winding includes the first hairpin HPa, and a first connection member CTa connected to the first hairpin HPa.

The first hairpin HPa at this time as a single hairpin may be a ‘U’-shaped hairpin.

Meanwhile, in the second area LA5 to LA8 between the outer periphery ORA and the inner periphery IRA of the stator core CRE, the parallel part WR3 of the first winding includes the second hairpin HPb, and the second connection member CTb connected to the second hairpin HPb.

At this time, the second hairpin HPb may be the continuous hairpin.

Meanwhile, the second hairpin HPb may include only a third pin part PTa at an equal third interval unlike FIG. 10A.

That is, the second hairpin HPb may not include the first pin part PTb or the second pin part PTc of FIG. 10A.

At this time, the third interval may be greater than the first interval and less than the second interval. For example, the third pin part PTa may be disposed at an interval of six slots.

Meanwhile, in the first winding of FIG. 11A, a number of welding members CNTa1 in the first area LA1 to LA4 may be approximately 16, and a number of welding members CNTb1 in the second area LA5 to LA8 may be approximately 4.

Accordingly, the resistance in the second area LA5 to LA8 may be reduced, and it is possible to reduce the heat generation upon the motor rotation. In particular, the heat generation may be reduced around the inner periphery IRA of the stator core CRE.

Meanwhile, when the first area LA1 to LA4 and the second area LA5 to LA8 are compared, it is desirable that a number of second connection members CTb1 is less than a number of first connection members CTa1. Accordingly, the heat generation may be reduced around the inner periphery IRA of the stator core CRE.

FIG. 11B illustrates the other part of the first winding in the stator according to an embodiment of the present disclosure.

Referring to the drawing, the parallel part WR4 of the first winding according to an embodiment of the present disclosure is connected in parallel in the second area LA5 to LA8.

Meanwhile, the serial part WR2 of the first winding according to an embodiment of the present disclosure is connected in series in the first area LA1 to LA4.

Meanwhile, the first winding according to an embodiment of the present disclosure includes the first hairpin HPa disposed in the first area LA1 to LA4, and the second hairpin HPb which is disposed in the second area LA5 to LA8, and has the larger length than the first hairpin HPa.

Meanwhile, in the first area LA1 to LA4 between the outer periphery ORA and the inner periphery IRA of the stator core CRE, the serial part WR2 of the first winding includes the first hairpin HPa, and the first connection member CTa connected to the first hairpin HPa.

The first hairpin HPa at this time as a single hairpin may be a ‘U’-shaped hairpin.

Meanwhile, in the second area LA5 to LA8 between the outer periphery ORA and the inner periphery IRA of the stator core CRE, the parallel part WR4 of the first winding includes the second hairpin HPb, and the second connection member CTb connected to the second hairpin HPb.

At this time, the second hairpin HPb may be the continuous hairpin.

Meanwhile, the second hairpin HPb may include only a third pin part PTb at an equal third interval unlike FIG. 10B.

Meanwhile, in the first winding of FIG. 11B, a number of welding members CNTcl in the first area LA1 to LA4 may be approximately 16, and a number of welding members CNTd1 in the second area LA5 to LA8 may be approximately 4.

Accordingly, the resistance in the second area LA5 to LA8 may be reduced, and it is possible to reduce the heat generation upon the motor rotation. In particular, the heat generation may be reduced around the inner periphery IRA of the stator core CRE.

Meanwhile, when the first area LA1 to LA4 and the second area LA5 to LA8 are compared, it is desirable that a number of second connection members CTd1 is less than a number of first connection members CTc1. Accordingly, the heat generation may be reduced around the inner periphery IRA of the stator core CRE.

FIGS. 12A and 12B are yet another examples of the winding in the stator according to an embodiment of the present disclosure.

FIG. 12A illustrates a part of the first winding in the stator according to an embodiment of the present disclosure.

Referring to the drawing, the first winding according to an embodiment of the present disclosure includes the first hairpin HPa disposed in the first area LA1 to LA4, and the second hairpin HPb which is disposed in the second area LA5 to LA8, and has the larger length than the first hairpin HPa.

Specifically, the serial part WR1 of the first winding according to an embodiment of the present disclosure includes the first hairpin HPa disposed in the first area LA1 to LA4, and the parallel part WR3 of the first winding includes the second hairpin HPb disposed in the second area LA5 to LA8.

The first hairpin HPa and the second connection member CTb of FIG. 12A are similar to those of FIG. 10A or 11A, but the second hair pin HPb is partially different.

The second hairpin HPb of FIG. 12A is the continuous hairpin, and a third pin part PTa spaced at a third interval, a second pin part PTc spaced at a second interval greater than the third interval, and a first pin part PTb spaced at a first interval less than the third interval may be repeated.

As another example, the second hairpin HPb is the continuous hairpin, and the first pin part PTb spaced at the first interval, the third pin part PTa spaced at the third interval, the second pin part PTc spaced at the second interval, and the third pin part PTa spaced at the third interval may be repeated.

That is, a number of third pin parts PTa in the second hairpin HPb may be greater than a number of first pin parts PTb or a number of second pin parts PTc.

Due to such asymmetric placement, it is possible to reduce the heat generation upon the motor rotation. In particular, the AC resistance upon the motor rotation is reduced to reduce the heat generation. Furthermore, it is possible to reduce the heat generation upon the motor rotation based on asymmetric winding.

Meanwhile, when the first area LA1 to LA4 and the second area LA5 to LA8 are compared, it is desirable that a number of second connection members CTb2 is less than a number of first connection members CTa2. Accordingly, the heat generation may be reduced around the inner periphery IRA of the stator core CRE.

FIG. 12B illustrates the other part of the first winding in the stator according to an embodiment of the present disclosure.

Referring to the drawing, the serial part WR3 of the first winding according to an embodiment of the present disclosure includes the first hairpin HPa disposed in the first area LA1 to LA4, and the parallel part WR4 of the first winding includes the second hairpin HPb disposed in the second area LA5 to LA8.

The first hairpin HPa and the second connection member CTb of FIG. 12B are similar to those of FIG. 10A or 11A, but the second hair pin HPb is partially different.

The second hairpin HPb of FIG. 12A is the continuous hairpin, and a third pin part PTa spaced at a third interval, a second pin part PTc spaced at a second interval greater than the third interval, the third pin part PTa, and a first pin part PTb spaced at a first interval less than the third interval may be repeated.

As another example, the second hairpin HPb is the continuous hairpin, and the first pin part PTb spaced at the first interval, the third pin part PTa spaced at the third interval, the second pin part PTc spaced at the second interval, and the third pin part PTa spaced at the third interval may be repeated.

That is, a number of third pin parts PTa in the second hairpin HPb may be greater than a number of first pin parts PTb or a number of second pin parts PTc.

Due to such asymmetric placement, it is possible to reduce the heat generation upon the motor rotation. In particular, the AC resistance upon the motor rotation is reduced to reduce the heat generation. Furthermore, it is possible to reduce the heat generation upon the motor rotation based on asymmetric winding.

Meanwhile, when the first area LA1 to LA4 and the second area LA5 to LA8 are compared, it is desirable that a number of second connection members CTd2 is less than a number of first connection members CTc2. Accordingly, the heat generation may be reduced around the inner periphery IRA of the stator core CRE while a number of welding members is reduced.

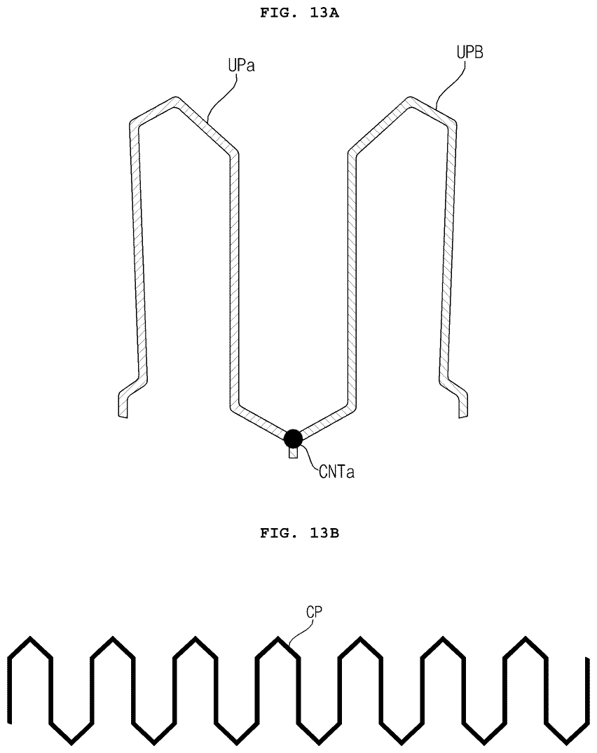

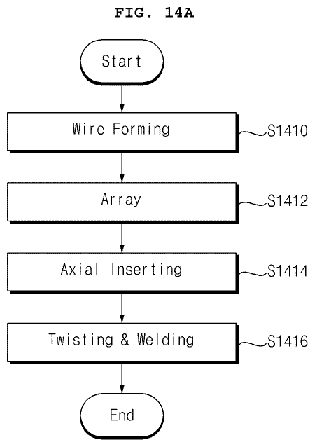

FIGS. 13A to 15D are diagrams referred to in the description of FIGS. 10A to 12B.

First, FIG. 13A is a diagram illustrating connection of a plurality of first hairpins according to an embodiment of the present disclosure.

Referring to the drawing, for connection of the plurality of first hairpins UPa and UPc, welding is required, and as a result, a welding member CNTa by the welding is attached as illustrated in the drawing.

FIG. 13B illustrates an example of a second hair pin according to an embodiment of the present disclosure.

Referring to the drawing, the second hairpin CP as a continuous hairpin may include a plurality of pin parts.

For example, the second hairpin CP may include the first pin part PTb spaced at the first interval, and the second pin part PTc connected to the first pin part PTb, and spaced at the second interval greater than the first interval as illustrated in FIGS. 10A and 10B.

As another example, the second hairpin HPb may include the third pin part PTa at the equal third interval as illustrated in FIGS. 11A and 11B.

As yet another example, the second hairpin CP may include the first pin part PTb spaced at the first interval, and the second pin part PTc spaced at the second interval, and the third pin part PTa spaced at the third interval as illustrated in FIGS. 12A and 12B.

Due to the second hairpin CP, a number of welding members is remarkably reduced, and as a result, the heat generation upon the motor oration may be reduced while a number of welding members is reduced. In particular, the heat generation may be reduced around the inner periphery IRA of the stator core CRE while a number of welding members is reduced.

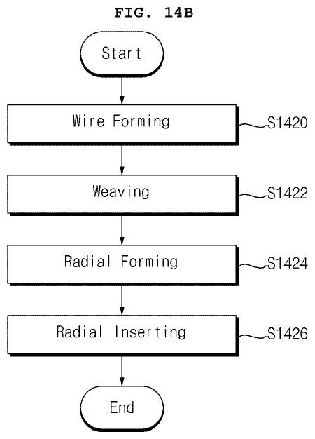

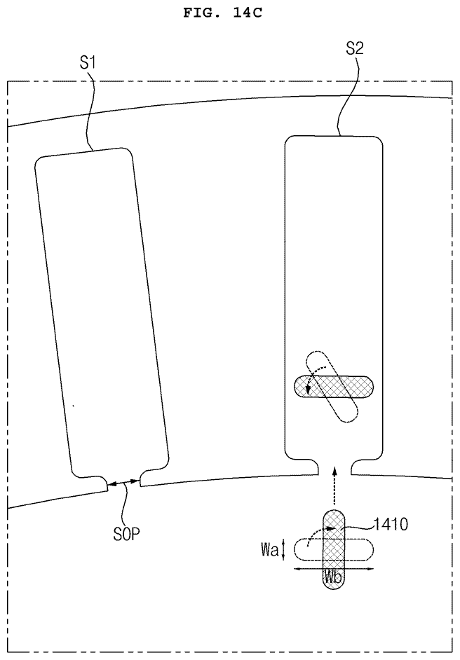

FIG. 14A is an example of a flowchart for mounting the first hairpin on the stator core.

Referring the drawing, first, a wire is molded in a U shape (S1410). Accordingly, one first hairpin HPa may be formed as illustrated in FIG. 13A.

Next, a plurality of first hairpins HPa are arranged (S1412).

Next, the plurality of arranged first hairpins HPa are inserted into the stator core CRE (S1414).

When the first hairpin HPa is inserted, the first hairpin HPa may be rotated to pass through an opening of a slot of the stator core CRE.

Next, the first hairpin HPa inserted into the stator core CRE is twisted and welded (S1416).

Accordingly, as illustrated in FIG. 13A, the welding member CNTa is attached by performing welding between the first hairpins HPa.

FIG. 14B is an example of a flowchart for mounting the second hairpin on the stator core.

Referring the drawing, first, the wire is molded as the continuous hairpin (S1420). Accordingly, the continuous hairpin may be formed as illustrated in FIG. 13B.

Next, two hairpins HPb are weaved for parallel connection (S1422).

Next, the second hairpin HPb is molded radially (S1424). That is, the second hairpin HPb is molded to have a cylindrical shape.

Next, the second hairpin HPb is inserted into the stator core CRE (S1426). When the second hairpin HPb is inserted, the second hairpin HPb may pass through the opening of the slot of the stator core CRE.

FIG. 14C illustrates that the hairpin is inserted into the slot in the stator core.

Referring to the drawing, it is desirable that when the hairpins 1410 are inserted into the slots S1 and S2 in the stator core CRE, the hairpins 1410 are rotated to pass through the openings SOP of the slots S1 and S2.

Accordingly, a width Wa of a hairpin 1410 greater than the opening SOP may be reduced to Wb less than the opening SOP, so the hairpin 1410 passes through the opening SOP to be mounted inside the slots S1 and S2.

At this time, the hairpin 1410 may be the first hairpin HPa. Furthermore, it is also possible that the hairpin 1410 is the second hairpin HPb.

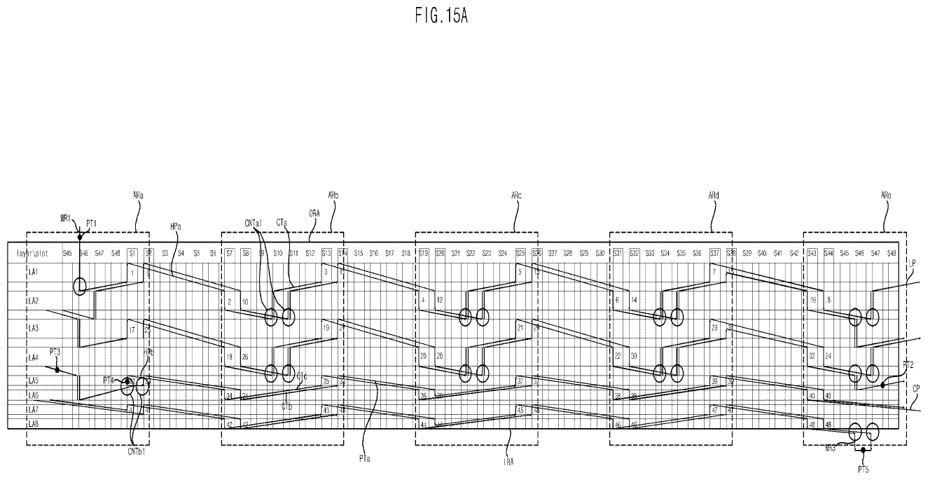

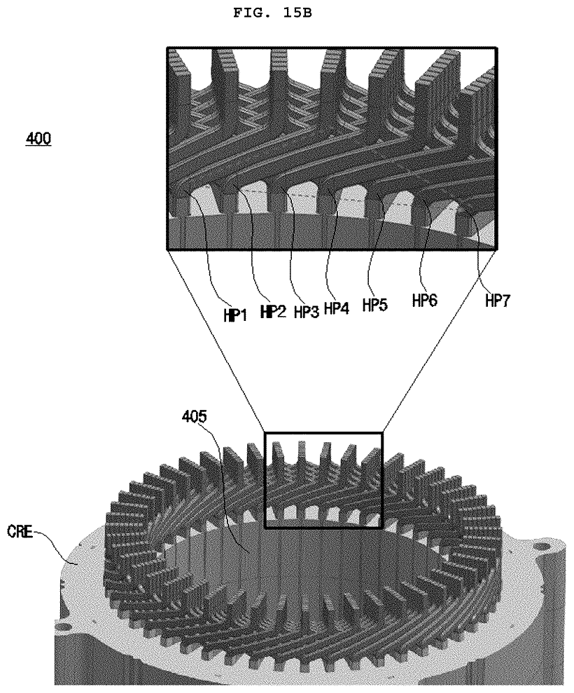

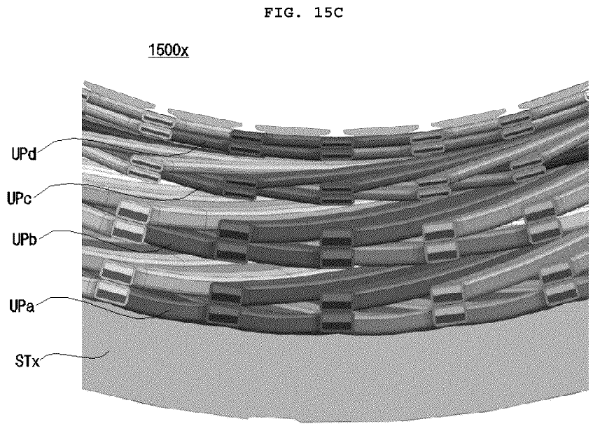

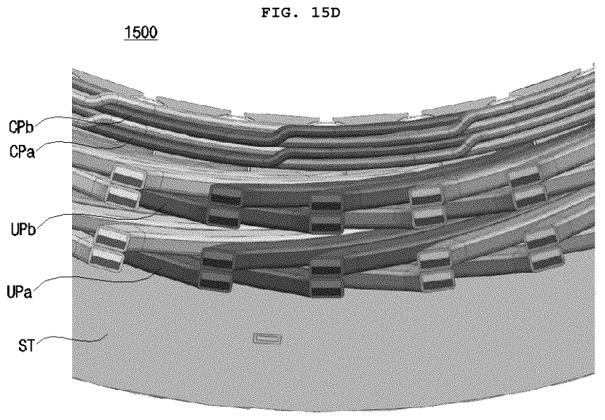

FIG. 15A illustrates a part of the first winding according to an embodiment of the present disclosure.

Referring to the drawing, the first winding 1500x according to an embodiment of the present disclosure includes the first hairpin HPa disposed in the first area LA1 to LA4, and the second hairpin HPb which is disposed in the second area LA5 to LA8, and has the larger length than the first hairpin HPa.

Meanwhile, in the drawing, in a plurality of areas Ara, Arb, Arc, Ard, and Are among areas in which the first winding is disposed, the first hairpins HPa are disposed at an interval of six slots.

Meanwhile, in the drawing, in the plurality of areas Ara, Arb, Arc, Ard, and Are among areas in which the first winding is disposed, an interval of the pin parts in the second hairpin HPb may be the interval of six slots.

That is, the first hairpin HPa or the second hairpin HPb may be disposed while moving at an interval of six pitches or six slots.

FIG. 15B illustrates the interval of six pitches or six slots.

Referring to the drawing, a plurality of first hairpins disposed in the stator core CRE are illustrated as in HP1, HP2, HP3, HP4, HP5, HP6, and HP7, and upon twisting in step 1416 (S1416) of FIG. 14A, the first hairpins may be twisted at the interval of six pitches or six slots.

FIG. 15C is a diagram: illustrating a plurality of hairpins related to the present disclosure.

Referring to the drawing, the first winding 1500 related to the present disclosure includes a plurality of U pin-shaped hairpins UPa, UPb, UPc, and UPd in a slot STx.

Accordingly, since each of the plurality of hairpins UPa, UPb, UPc, and UPd needs to be welded, motor manufacturing may not be easy due to welding increasing.

FIG. 15D is a diagram illustrating a plurality of hairpins according to an embodiment of the present disclosure.

Referring to the drawing, the first winding related to the present disclosure includes first hairpins UPa and UPb having a U pin shape and second hairpins CPa and CPb which are continuous hairpins.

Accordingly, since welding is remarkably reduced due to the second hairpins CPa and CPb, the heat generation upon the motor rotation may be consequently reduced while a number of welding members is reduced. In particular, the heat generation may be reduced around the inner periphery of the stator core while a number of welding members is reduced.

As described above, a stator and a motor including the same according to an embodiment of the present disclosure include: a stator core in which a plurality of slots are formed; and a plurality of windings between an inner periphery and an outer periphery of the stator core, and a first winding corresponding to a first phase among the plurality of windings is disposed throughout a plurality of layers between the outer periphery and the inner periphery of the stator core, a thickness of a second layer adjacent to the inner periphery is less than a thickness of a first layer adjacent to the outer periphery among the plurality of layers, and the first winding is connected in series in a first area between the outer periphery and the inner periphery of the stator core, and connected in parallel in a second area closer to the inner periphery than the first area between the outer periphery and the inner periphery, and the first winding includes a first hairpin disposed in the first area, and a second hairpin disposed in the second area and having a larger length than the first hairpin. Accordingly, it is possible to reduce the heat generation upon the motor rotation while a number of welding members is reduced. In particular, the heat generation may be reduced around the inner periphery of the stator core while a number of welding members is reduced.

Meanwhile, the first winding may further include a first connection member connected to the first hairpin in the first area, and a second connection member connected to the second hairpin in the second area. Accordingly, it is possible to reduce the heat generation upon the motor rotation while a number of welding members is reduced.

Meanwhile, a number of second connection members may be less than a number of first connection members. Accordingly, it is possible to reduce the heat generation upon the motor rotation while a number of welding members is reduced.

Meanwhile, the second hairpin may include a first pin part spaced at a first interval, and a second pin part connected to the first pin part, and spaced at a second interval greater than the first interval. Accordingly, it is possible to reduce the heat generation upon the motor rotation while a number of welding members is reduced.

Meanwhile, the second hairpin may include pin parts spaced at an equal interval. Accordingly, it is possible to reduce the heat generation upon the motor rotation while a number of welding members is reduced.

Meanwhile, the second hairpin may include a first pin part spaced at a first interval, a second pin part spaced at a second interval greater than the first interval, and a third pin part spaced at a third interval greater than the first interval and less than the second interval. Accordingly, it is possible to reduce the heat generation upon the motor rotation while a number of welding members is reduced.

Meanwhile, a number of third pin parts in the second hairpin may be greater than a number of first pin parts or a number of second pin parts. Accordingly, it is possible to reduce the heat generation upon the motor rotation while a number of welding members is reduced.

Meanwhile, a size of the first area may be greater than a size of the second area. Accordingly, it is possible to reduce the heat generation upon the motor rotation while a number of welding members is reduced.

Meanwhile, a thickness of the first hairpin may be greater than a thickness of the second hairpin. Accordingly, it is possible to reduce the heat generation upon the motor rotation while a number of welding members is reduced.

Meanwhile, the first winding may include even wires. Accordingly, it is possible to reduce the heat generation upon the motor rotation while a number of welding members is reduced.

Meanwhile, the first winding may be disposed throughout first to eighth layers toward the inner periphery from the outer periphery, and a thickness of the fifth to eighth layers may be less than a thickness of the first to fourth layers. Accordingly, it is possible to reduce the heat generation upon the motor rotation while a number of welding members is reduced.

Meanwhile, some of the even wires in the first winding may be disposed in series in the first layer and the third layer, and disposed in parallel in the fifth layer and the seventh layer, and other some of the even wires in the first winding may be disposed in series in the second layer and the fourth layer, and disposed in parallel in the sixth layer and the eighth layer. Accordingly, it is possible to reduce the heat generation upon the motor rotation while a number of welding members is reduced.

In accordance with another aspect of the present disclosure, a stator and a motor including the same include: a stator core in which a plurality of slots are formed; and a plurality of windings between an inner periphery and an outer periphery of the stator core, and a first winding corresponding to a first phase among the plurality of windings is disposed throughout a plurality of layers between the outer periphery and the inner periphery of the stator core, the first winding further includes a first hairpin disposed in a first area between the outer periphery and the inner periphery of the stator core, and second hairpin disposed in a second area closer to the inner periphery than the first area, and having a larger length than the first hairpin, and a number of second hairpins is less than a number of first hairpins. Accordingly, it is possible to reduce the heat generation upon the motor rotation while a number of welding members is reduced. In particular, the heat generation may be reduced around the inner periphery of the stator core.

While the embodiments of the present disclosure have been illustrated and described above, the present disclosure is not limited to the aforementioned specific embodiments, various modifications may be made by a person with ordinary skill in the technical field to which the present disclosure pertains without departing from the subject matters of the present disclosure that are claimed in the claims, and these modifications should not be appreciated individually from the technical spirit or prospect of the present disclosure.

What is claimed is:

1. A stator comprising:
a stator core in which a plurality of slots are formed; and
a plurality of windings between an inner periphery and an outer periphery of the stator core,
wherein a first winding corresponding to a first phase among the plurality of windings is disposed throughout a plurality of layers between the outer periphery and the inner periphery of the stator core,
wherein a thickness of a second layer adjacent to the inner periphery is less than a thickness of a first layer adjacent to the outer periphery among the plurality of layers, and
wherein the first winding is connected in series in a first area between the outer periphery and the inner periphery of the stator core, and the first winding is connected in parallel in a second area closer to the inner periphery than the first area between the outer periphery and the inner periphery, and
wherein the first winding includes:
a first hairpin disposed in the first area, and
a second hairpin disposed in the second area and having a larger length than the first hairpin.

2. The stator of claim 1, wherein the first winding further includes:
a first connection member connected to the first hairpin in the first area, and
a second connection member connected to the second hairpin in the second area.

3. The stator of claim 2, wherein a number of second connection members is less than a number of first connection members.

4. The stator of claim 1, wherein the second hairpin includes:
a first pin part spaced at a first interval, and
a second pin part connected to the first pin part, and spaced at a second interval greater than the first interval.

5. The stator of claim 1, wherein the second hairpin includes pin parts spaced at an equal interval.

6. The stator of claim 1, wherein the second hairpin includes:
a first pin part spaced at a first interval,
a second pin part spaced at a second interval greater than the first interval, and
a third pin part spaced at a third interval greater than the first interval and less than the second interval.

7. The stator of claim 6, wherein a number of third pin parts in the second hairpin is greater than a number of first pin parts or a number of second pin parts.

8. The stator of claim 1, wherein a size of the first area is greater than a size of the second area.

9. The stator of claim 1, wherein a thickness of the first hairpin is greater than a thickness of the second hairpin.

10. The stator of claim 1, wherein the first winding includes even wires.

11. The stator of claim 1, wherein the first winding is disposed throughout first to eighth layers toward the inner periphery from the outer periphery, and
wherein a thickness of the fifth to eighth layers is less than a thickness of the first to fourth layers.

12. The stator of claim 11, wherein some of the even wires in the first winding are disposed in series in the first layer and the third layer, and disposed in parallel in the fifth layer and the seventh layer, and
wherein other some of the even wires in the first winding are disposed in series in the second layer and the fourth layer, and disposed in parallel in the sixth layer and the eighth layer.

13. A stator comprising:
a stator core in which a plurality of slots are formed; and
a plurality of windings between an inner periphery and an outer periphery of the stator core,
wherein a first winding corresponding to a first phase among the plurality of windings is disposed throughout a plurality of layers between the outer periphery and the inner periphery of the stator core,
wherein the first winding further includes:
a first hairpin disposed in a first area between the outer periphery and the inner periphery of the stator core, and
a second hairpin disposed in a second area closer to the inner periphery than the first area, and having a larger length than the first hairpin, and
wherein a number of second hairpins is less than a number of first hairpins.

14. The stator of claim 13, further comprising:
a first connection member connected to the first hairpin in the first area, and
a second connection member connected to the second hairpin in the second area.

15. The stator of claim 14, wherein a number of second connection members is less than a number of first connection members.

16. The stator of claim 13, wherein the second hairpin includes:
a first pin part spaced at a first interval, and
a second pin part connected to the first pin part, and spaced at a second interval greater than the first interval.

17. The stator of claim 13, wherein the second hairpin includes pin parts spaced at an equal interval.

18. The stator of claim 13, wherein the second hairpin includes:
a first pin part spaced at a first interval, and
a second pin part spaced at a second interval greater than the first interval, and
a third pin part spaced at a third interval greater than the first interval and less than the second interval.

19. The stator of claim 18, wherein a number of third pin parts in the second hairpin is greater than a number of first pin parts or a number of second pin parts.

20. A motor comprising:
a stator; and
a rotor disposed in a hollow in the stator and rotated
wherein the stator comprises:
a stator core in which a plurality of slots are formed; and
a plurality of windings between an inner periphery and an outer periphery of the stator core,
wherein a first winding corresponding to a first phase among the plurality of windings is disposed throughout a plurality of layers between the outer periphery and the inner periphery of the stator core,
wherein a thickness of a second layer adjacent to the inner periphery is less than a thickness of a first layer adjacent to the outer periphery among the plurality of layers, and
wherein the first winding is connected in series in a first area between the outer periphery and the inner periphery of the stator core, and the first winding is connected in parallel in a second area closer to the inner periphery than the first area between the outer periphery and the inner periphery, and
wherein the first winding includes:
a first hairpin disposed in the first area, and
a second hairpin disposed in the second area and having a larger length than the first hairpin.
